(19) United States
(12) Patent Application Publication
(10) Pub. No.: US 2026/0162621 A1
(43) Pub. Date: Jun. 11, 2026

(54) GATE DRIVER AND DISPLAY DEVICE INCLUDING THE SAME

(71) Applicant: LG DISPLAY CO., LTD., SEOUL (KR)

(72) Inventors: In Kang, Seoul (KR); DaeSung Jung, Paju-si (KR); DaeKyu Kim, Seoul (KR)

(21) Appl. No.: 19/374,389

(22) Filed: Oct. 30, 2025

(30) Foreign Application Priority Data
Dec. 10, 2024 (KR) 10-2024-0182325

(51) Int. Cl. G09G 3/3266; G09G 3/3233

(52) U.S. Cl. CPC G09G 3/3266; G09G 3/3233; G09G 2300/0819; G09G 2300/0842; G09G 2300/0861; G09G 2310/0286; G09G 2310/08; G09G 2320/0223; G09G 2330/021

(57) ABSTRACT

A gate driver includes cascaded stages and outputs gate signals based on an input signal, a reset signal, at least one of first, second, third, and fourth clock signals, a first power source, and a second power source with lower voltage than the first power source. A first stage includes a first node controller to control a voltage of a first node based on the input signal, the first clock signal, the first power source, and a voltage of a second node, a second node controller to control a voltage of the second node based on the input signal, the fourth clock signal, the first power source, and the second power source, an output circuit that selectively outputs the second clock signal or a voltage of the first power source, based on voltages of third and second nodes, and a bridge voltage transistor connected between the first and third nodes.

### CROSS-REFERENCE TO RELATED APPLICATIONS

Pursuant to 35 U.S.C. § 119(a), this application claims the benefit of an earlier filing date and right of priority to Korean Patent Application No. 10-2024-0182325 filed on Dec. 10, 2024, in the Korean Intellectual Property Office, the disclosure of which is incorporated herein by reference in its entirety.

### TECHNICAL FIELD

The present disclosure relates to a gate driver and a display device including the same.

### BACKGROUND

In the information era, a display field which visually expresses electrical information signals has been rapidly developed. Various display devices having excellent performance such as reduced thickness, lighter weight, and lower power consumption have been developed. As an example of the display device as described above, there is an organic light emitting display device (OLED).

### SUMMARY

A gate driver according to an example implementation of the present disclosure includes a plurality of stages which are cascaded to each other and outputs a plurality of gate signals based on an input signal, a reset signal, at least one clock signal among first, second, third and fourth clock signals, a first power source, and a second power source which has a voltage level lower than the first power source, wherein a first stage, among the plurality of stages, includes a first node controller circuit which controls a voltage of a first node based on the input signal, the first clock signal, the first power source, and a voltage of a second node, a second node controller circuit which controls a voltage of the second node based on the input signal, the fourth clock signal, the first power source, and the second power source, an output circuit which selectively outputs the second clock signal or a voltage of the first power source, based on a voltage of a third node and the voltage of the second node and a bridge voltage transistor connected between the first node and the third node.

A gate driver according to other example implementation of the present disclosure includes a plurality of stages which are cascaded to each other and outputs a plurality of gate signals based on an input signal, a reset signal, at least one clock signal among first, second, third and fourth clock signals, a first power source, and a second power source which has a voltage level lower than the first power source, wherein a first stage, among the plurality of stages, includes a first node controller circuit which controls a voltage of a first node based on the input signal, the first clock signal, the first power source, and a voltage of a second node, a second node controller circuit which controls the voltage of the second node based on the input signal, the fourth clock signal, the first power source, and the second power source, an output circuit which selectively outputs the second clock signal or a voltage of the first power source, based on a voltage of a third node and the voltage of the second node and a reset circuit which controls the voltage of the first node and the voltage of the second node based on the reset signal, the first power source, and the second power source.

A display device according to an example implementation of the present disclosure includes a display panel which includes a plurality of pixels; and a gate driver according to the example implementation of the present disclosure, wherein the plurality of gate signals are output to the plurality of pixels.

A display device according to other example implementation of the present disclosure includes a display panel which includes a plurality of pixels; and a gate driver according to the other example implementation of the present disclosure, wherein the plurality of gate signals are output to the plurality of pixels.

Other detailed matters of the example implementations are included in the detailed description and the drawings.

### BRIEF DESCRIPTION OF DRAWINGS

FIG. 1 is a diagram of a display device according to example implementations of the present disclosure;

FIG. 2 is a block diagram illustrating a display device according to example implementations of the present disclosure;

FIG. 3 is a circuit diagram illustrating an example of a pixel included in a display device of FIG. 2;

FIG. 4 is a waveform chart for explaining an example of an operation of a pixel of FIG. 3;

FIG. 5 is a circuit diagram illustrating another example of a pixel included in a display device of FIG. 2;

FIGS. 6A and 6B are waveform charts for explaining an example of an operation of a pixel of FIG. 5;

FIGS. 7 and 8 are cross-sectional views illustrating a part of a display device according to example implementations of the present disclosure;

FIG. 9 is a view for explaining an example of a placement structure of a gate driver included in a display device of FIG. 2;

FIG. 10 is a block diagram illustrating a gate driver according to example implementations of the present disclosure;

FIG. 11 is a circuit diagram illustrating an example of a first stage included in a gate driver of FIG. 10;

FIG. 12 is a waveform chart for explaining an example of an operation of a first stage of FIG. 11;

FIGS. 13A to 13E are equivalent circuit diagrams for explaining an example of an operation of a first stage of FIG. 11; and

FIG. 14 is a view for explaining an example of a gate signal output from a gate driver of FIG. 10.

### DETAILED DESCRIPTION

A display device generally includes a display panel in which a plurality of pixels for displaying images is disposed and a driving circuit, such as a data driver, a gate driver, and a timing controller. The data driver supplies a data signal to a plurality of data lines disposed in the display panel, the gate driver sequentially supplies a gate signal to a plurality of gate lines disposed in the display panel, and the timing controller controls the data driver and the gate driver.

Implementations of the present disclosure can provide a gate driver in which a voltage level of an output signal (gate signal) is stabilized, and a display device including the same.

In the gate driver according to the example implementations of the present disclosure and the display device including the same, a first node controller which controls a first node (or a Q1 node) of a stage may be connected to an input terminal to which a start signal is input. Here, the start signal may be maintained at a gate-off level (high level) after a gate-on level (low level) of gate signal is output.

Accordingly, after the gate-on level (low level) of gate signal is output, the first node (or Q1 node) of the corresponding stage may be stably maintained at a gate-off level (high level) and may also stably maintain the gate signal at a gate-off level (high level), in response to this.

The effects according to the present disclosure are not limited to the contents exemplified above, and more various effects are included in the present specification.

Advantages and characteristics of the present disclosure and a method of achieving the advantages and characteristics will be clear by referring to example implementations described below in detail together with the accompanying drawings. However, the present disclosure is not limited to the example implementations disclosed herein but will be implemented in various forms. The example implementations are provided by way of example only so that those skilled in the art can fully understand the disclosures of the present disclosure and the scope of the present disclosure. Therefore, the present disclosure will be defined only by the scope of the appended claims.

The shapes, sizes, ratios, angles, numbers, and the like illustrated in the accompanying drawings for describing the example implementations of the present disclosure are merely examples, and the present disclosure is not limited thereto. Like reference numerals generally denote like elements throughout the specification. Further, in the following description of the present disclosure, a detailed explanation of known related technologies may be omitted to avoid unnecessarily obscuring the subject matter of the present disclosure. The terms such as “including,” “having,” and “consist of” used herein are generally intended to allow other components to be added unless the terms are used with the term “only”. Any references to singular may include plural unless expressly stated otherwise.

In describing components of the example implementation of the present disclosure, terminologies such as first, second, A, B, (a), (b), and the like may be used. These terminologies are used to distinguish a component from the other component, but a nature, an order, or the number of the components is not limited by the terminology. When a component is “linked”, “coupled”, or “connected” to another component, the component may be directly linked or connected to the other component. However, unless specifically stated otherwise, it should be understood that a third component may be interposed between the components which may be indirectly linked or connected.

When the position relation between two parts is described using the terms such as “on”, “above”, “below”, and “next”, one or more parts may be positioned between the two parts unless the terms are used with the term “immediately” or “directly”.

Although the terms “first”, “second”, and the like are used for describing various components, these components are not confined by these terms. These terms are merely used for distinguishing one component from the other components. Therefore, a first component to be mentioned below may be a second component in a technical concept of the present disclosure.

The features of various implementations of the present disclosure can be partially or entirely adhered to or combined with each other and can be interlocked and operated in technically various ways, and the implementations can be carried out independently of or in association with each other.

The following implementations will be described focusing on the organic light emitting display device. However, implementations of the present specification are not limited to organic light emitting display devices and can be applied to various electroluminescent displays. For example, the electroluminescent display apparatus may use an organic light emitting diode (OLED) display apparatus, a quantum dot light emitting diode display apparatus, or an inorganic light emitting diode display apparatus.

Hereinafter, example implementations of the present disclosure will be described in detail with reference to accompanying drawings.

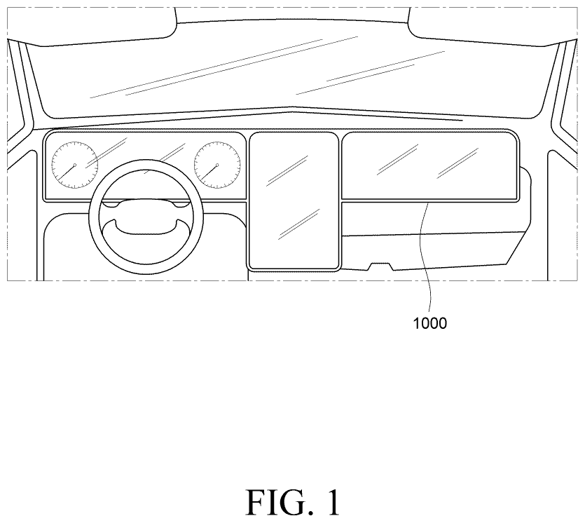

FIG. 1 is a diagram of a display device according to example implementations of the present disclosure.

Referring to FIG. 1, the display device 1000 may be disposed in at least a part of a dashboard of a vehicle. The dashboard of the vehicle may include a configuration disposed in front surfaces of front seats (for example, a driver seat and a front passenger seat) of the vehicle. For example, on the dashboard of the vehicle, an input configuration for manipulating various functions (for example, an air-conditioner, an audio system, or a navigation system) in the vehicle may be disposed.

The display device 1000 is disposed on the dashboard of the vehicle to operate as an input unit which manipulates at least a part of various functions of the vehicle. The display device 1000 may provide various information related to the vehicle, for example, operation information of the vehicle (for example, a current speed of the vehicle, a remaining fuel amount, or a mileage) or information about parts of the vehicle (for example, a damage level of a vehicle tire).

The display device 1000 may be disposed across the driver seat and the front passenger seat disposed in the front seats of the vehicle. A user of the display device 1000 may include a driver of the vehicle and a passenger riding on the front passenger seat. Both the vehicle driver and the passenger may use the display device 1000.

Only a part of the display device 1000 may be illustrated in FIG. 1. The display device 1000 illustrated in FIG. 1 may represent a display panel, among various configurations included in the display device 1000. Specifically, for example, the display device 1000 illustrated in FIG. 1 may represent at least a part of an active area and a non-active area of the display panel. Among the configurations of the display device 1000, configurations other than the parts illustrated in FIG. 1 may be mounted inside the vehicle (or at least a part of the inside of the vehicle).

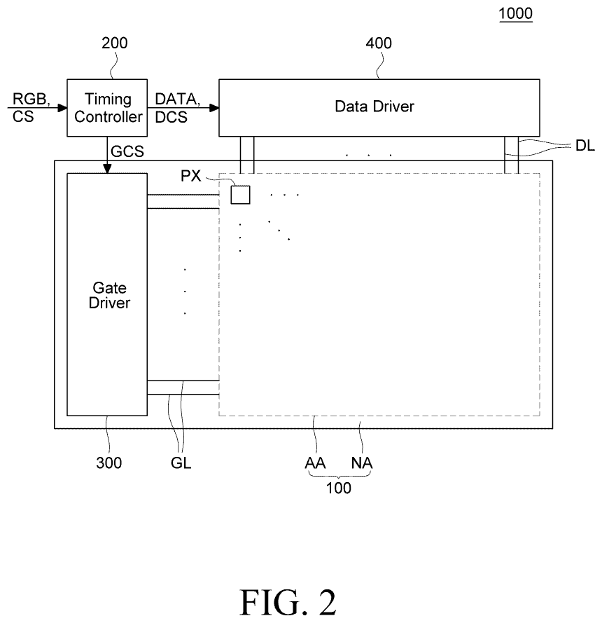

FIG. 2 is a block diagram illustrating a display device according to example implementations of the present disclosure.

The display device 1000 according to the example implementations of the present disclosure may be applied to the electroluminescent display device. The electroluminescent display device may use an organic light emitting diode (OLED) display device, a quantum dot light emitting diode display device, or an inorganic light emitting diode display device, but is not limited thereto.

Referring to FIG. 2, a display device 1000 according to example implementations of the present disclosure may include a display panel 100, a timing controller 200, a gate driver 300, and a data driver 400.

The display panel 100 may generate images to be provided to the user. For example, the display panel 100 may include an active area AA in which an image is displayed and a non-active area NA located at the outside of the active area AA. In the non-active area NA, various signal lines and the gate driver 300 may be disposed.

In the active area AA of the display panel 100, a plurality of pixels PX each including a pixel circuit may be disposed. Each of the plurality of pixels PX is connected to a corresponding gate line GL and a corresponding data line DL to display images in response to a gate signal supplied to the gate line GL and a data signal supplied to the data line DL.

The timing controller 200 may control the gate driver 300 and the data driver 400 based on input image RGB and a control signal CS supplied from the outside (for example, a host system, and the like). For example, the input control signal CS may include timing signals, such as a horizontal synchronization signal, a vertical synchronization signal, a data enable signal, and a clock signal and the timing controller 200 may generate a gate control signal GCS and a data control signal DCS based on the control signal CS. The gate control signal GCS may be supplied to the gate driver 300 and the data control signal DCS may be supplied to the data driver 400.

Further, the timing controller 200 realigns an input image RGB with a digital video data format in accordance with a resolution of the display panel 100 to generate image data DATA and provide the image data to the data driver 400.

The gate driver 300 may generate a gate signal based on the gate control signal GCS and output the gate signal to the plurality of gate lines GL. For example, the gate driver 300 may sequentially output the gate signal to the plurality of gate lines GL in the unit of pixel rows. To this end, the gate driver 300 may include a shift register or a level shifter. The gate control signal GCS may include a start signal, a plurality of clock signals, and a reset signal for generating gate signals.

In the example implementation, the gate driver 300 may generate a scan signal and an emission signal based on the gate control signal GCS. For example, the gate driver 300 may include at least one scan driver and at least one emission signal driver. The scan driver generates a scan signal in a row sequential manner to drive at least one or more scan lines connected to each pixel row to supply the scan signal to the plurality of scan lines. The emission signal driver generates an emission signal in a row sequential manner to drive at least one or more emission signal lines connected to each pixel row to supply the emission signal to the plurality of emission signal lines.

According to an example implementation, the gate driver 300 is formed in a thin film pattern when a substrate of the display panel 100 is manufactured to be embedded on the non-active area NA in a gate-driver in panel (GIP) manner. Even though in FIG. 2, only one gate driver 300 is disposed on the non-active area NA of the display panel 100, this is just illustrative, but the example implementation of the present disclosure is not limited thereto. For example, the gate driver 300 is divided into a plurality of units to be disposed on the non-active areas NA located on at least two side surfaces of the display panel 100.

However, the example implementation of the present disclosure is not limited thereto and the gate driver 300 is disposed on the active area AA of the display panel 100 together with the pixel PX to supply a gate signal to the pixel PX. For example, the gate driver 300 may be disposed in the display panel 100 in a gate-driver in active area (GIA) manner.

The data driver 400 converts digital image data DATA supplied from the timing controller 200 into an analog data signal based on the data control signal DCS to supply the converted analog data signal to the plurality of data lines DL.

The data driver 400 is connected to a bonding pad of the display panel 100 in a chip on glass (COG) manner or may be directly disposed on the display panel 100. According to the example implementation, the data driver 400 may be disposed to be integrated with the display panel 100. Further, the data driver 400 may be disposed in a chip on film (COF) manner.

In one example implementation, one pixel PX may include a plurality of sub pixels which emits different color light. For example, one pixel PX uses three sub pixels to implement blue, red, and green. However, it is not limited thereto and in some cases, the pixel PX may further include a sub pixel for further implementing a specific color, for example, white. In some implementations, in the pixel PX, an area which emits blue light may be referred to as a blue sub pixel, an area which emits red light may be referred to as a red sub pixel, and an area which emits green light may be referred to as a green sub pixel.

According to the example implementation, when the display panel 100 is used for the vehicle which has been described with reference to FIG. 1, a field of view of at least a partial area of the display panel 100 needs to be restricted according to the user's request. For example, images displayed in a region of an active area AA of the display panel 100 which provides an entertainment function and seat information for the passenger sitting on the front passenger seat may interrupt the driving of the driver. Accordingly, according to the user's request, a field of view of the image displayed in the corresponding area needs to be restricted.

To this end, according to the example implementation, each of the plurality of pixels PX may include a first light emitting diode and a second light emitting diode which emit the same color light. Each of the plurality of pixels PX may include a first optical member which reflects light from the first light emitting diode to a specific direction and a second optical member which reflects light from the second light emitting diode to a specific direction. For example, the first optical member and the second optical member may be implemented as lenses, but the example implementation of the present disclosure is not limited thereto. For example, the first optical member may be disposed in an optical area in which light is provided in a first range to form a first viewing angle and the second optical member may be disposed in an optical area in which light is provided in a second range to form a second viewing angle. The first range may be larger than the second range. Therefore, the first optical member and the second optical member may limit a viewing angle of each of the plurality of pixels PX.

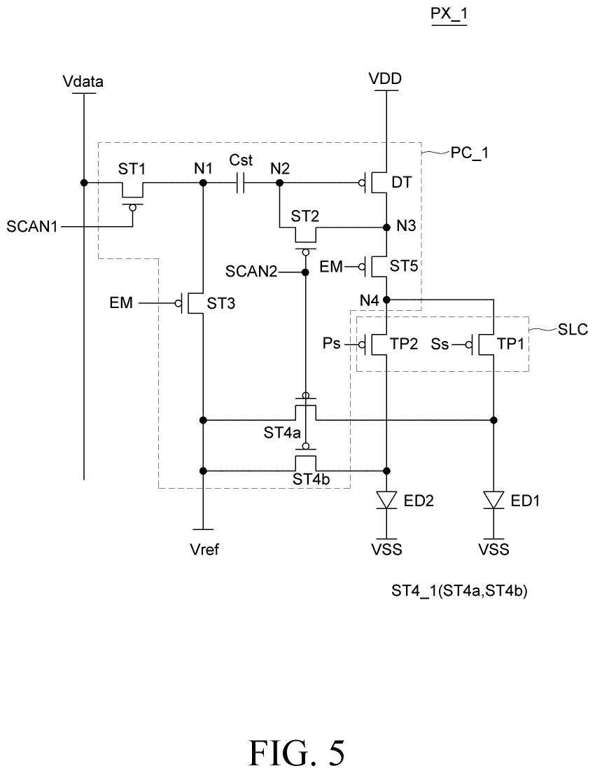

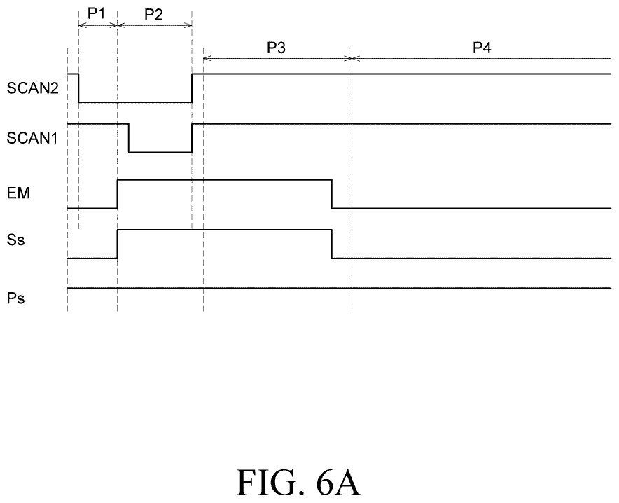

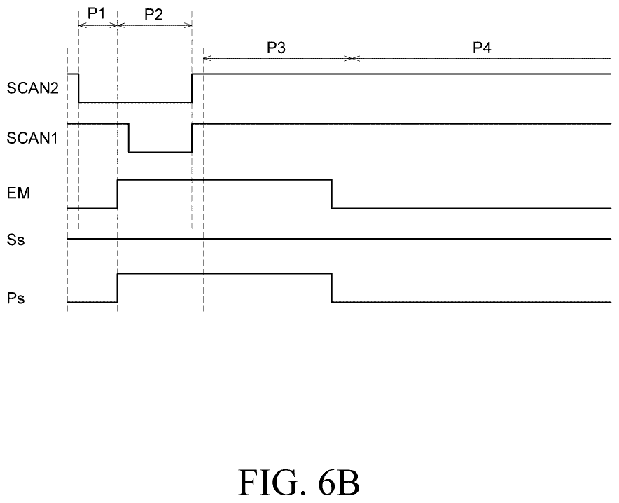

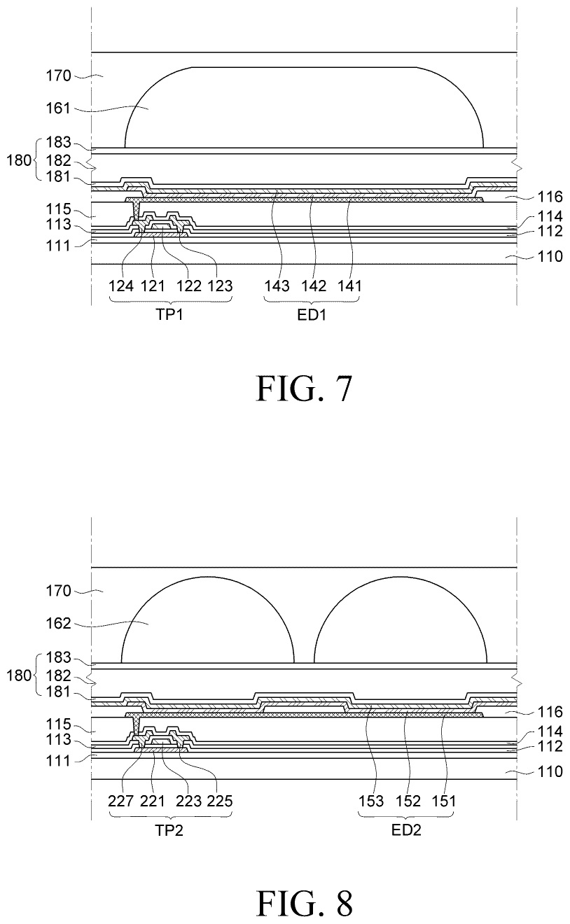

Here, in order to limit the field of view of an image which is displayed in a specific region as described above, each pixel PX included in the display panel 100 may be driven in a first mode or a second mode according to the driving mode. For example, when the pixel PX is driven in the first mode, a first light emitting diode included in a pixel PX emits light based on a selection signal to provide light from the first light emitting diode in a first range through the first optical member, to form a first viewing angle, for example, a wide viewing angle. In addition, when the pixel PX is driven in the second mode, a second light emitting diode included in a pixel PX emits light based on a selection signal to provide light from the second light emitting diode in a second range through the second optical member, to form a second viewing angle, for example, a narrow viewing angle. Here, the first mode may correspond to a mode in which the pixel PX is controlled in a wide field-of-view mode (share mode) and the second mode may correspond to a mode in which the pixel PX is driven in a narrow field-of-view mode (private mode). The driving of the pixel PX in a first mode and a second mode will be described in more detail with reference to FIGS. 5 to 6B and the first optical member and the second optical member will be described in more detail below with reference to FIGS. 7 and 8.

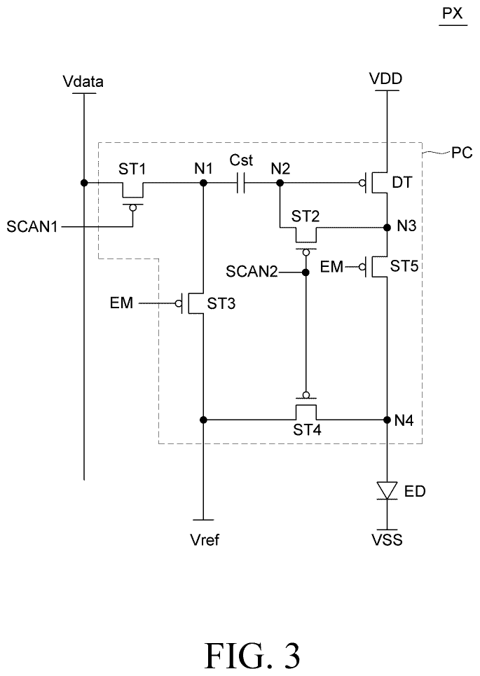

FIG. 3 is a circuit diagram illustrating an example of a pixel included in a display device of FIG. 2.

In some implementations, the pixel PX illustrated in FIG. 3 represents an example of the pixel PX included in the display device 1000 which has been described with reference to FIG. 2.

Referring to FIG. 3, the pixel PX according to the example implementation of the present disclosure may include a pixel circuit PC and a light emitting diode ED connected to the pixel circuit PC.

The pixel circuit PC may include a driving transistor DT, a plurality of switching transistors ST1 to ST5, and a storage capacitor Cst.

The driving transistor DT may control a driving current applied to the light emitting diode ED in accordance with a source-gate voltage. The driving transistor DT may include a source electrode connected to a high potential power line which supplies a high potential power voltage VDD, a gate electrode connected to a second node N2, and a drain electrode connected to a third node N3.

A first switching transistor ST1 may apply a data voltage Vdata from the data line DL to a first node N1. The first switching transistor ST1 may include a source electrode connected to the data line DL, a drain electrode connected to the first node N1, and a gate electrode connected to a first scan signal line to which a first scan signal SCAN1 is applied. The first switching transistor ST1 may be turned on or turned off by the first scan signal SCAN1. Accordingly, the first switching transistor ST1 may apply a data voltage Vdata from the data line DL to the first node N1, in response to a low level of first scan signal SCAN1 which is a turn-on level.

A second switching transistor ST2 may diode-connect the gate electrode and the drain electrode of the driving transistor DT. The second switching transistor ST2 may include a drain electrode connected to a second node N2, a source electrode connected to a third node N3, and a gate electrode connected to a second scan signal line to which a second scan signal SCAN2 is applied. The second switching transistor ST2 may be turned on or turned off by the second scan signal SCAN2. Therefore, the second switching transistor ST2 may diode-connect the gate electrode and the drain electrode of the driving transistor DT, in response to a low level of second scan signal SCAN2 which is a turn-on level.

A third switching transistor ST3 may apply a reference voltage Vref to the first node N1. The third switching transistor ST3 may include a source electrode which is connected to the reference voltage line which supplies the reference voltage Vref, a drain electrode which is connected to the first node N1, and a gate electrode which is connected to the emission signal line to which the emission signal EM is applied. The third switching transistor ST3 may be turned on or turned off by the emission signal EM. Accordingly, the third switching transistor ST3 may transmit the reference voltage Vref to the first node N1, in response to a low level of emission signal EM which is a turn-on level.

A fourth switching transistor ST4 may apply a reference voltage Vref to a fourth node N4 which is an anode electrode of the light emitting diode ED. The fourth switching transistor ST4 may include a source electrode connected to the reference voltage line which supplies the reference voltage Vref, a drain electrode connected to the fourth node N4, and a gate electrode connected to a second scan signal line to which a second scan signal SCAN2 is applied. The fourth switching transistor ST4 may be turned on or turned off by the second scan signal SCAN2. Therefore, the fourth switching transistor ST4 may apply the reference voltage Vref to the fourth node N4, that is, the anode electrode of the light emitting diode ED in response to the low level of second scan signal SCAN2 which is a turn-on level.

A fifth switching transistor ST5 may form a current path between the driving transistor DT and the light emitting diode ED. The fifth switching transistor ST5 may include a source electrode connected to the third node N3, a drain electrode connected to the fourth node N4, and a gate electrode connected to the emission signal line to which an emission signal EM is applied. The fifth switching transistor ST5 may be turned on or turned off by the emission signal EM. Therefore, the fifth switching transistor ST5 electrically connects the third node N3 and the fourth node N4 in response to a low level of emission signal EM which is a turn-on level to form a current path between the driving transistor DT and the light emitting diode ED.

The storage capacitor Cst may include a first electrode connected to the first node N1 and a second electrode connected to the second node N2. For example, one electrode of the storage capacitor Cst may be connected to the gate electrode of the driving transistor DT and the other electrode of the storage capacitor Cst may be connected to the first switching transistor ST1. The storage capacitor Cst stores a predetermined voltage to constantly maintain a voltage of the gate electrode of the driving transistor DT while the light emitting diode ED emits light.

The light emitting diode ED is connected to the pixel circuit PC to emit light by a driving current which is controlled by the pixel circuit PC. The light emitting diode ED may be connected between the fifth switching transistor ST5 and the low potential power line which supplies a low potential power voltage VSS. For example, the anode electrode of the light emitting diode ED may be connected to the fourth node N4 and the cathode electrode may be connected to a low potential power line.

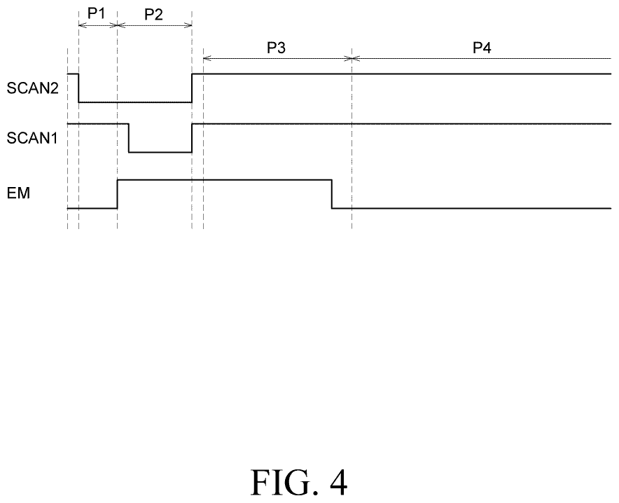

FIG. 4 is a waveform chart for explaining an example of an operation of a pixel of FIG. 3.

Referring to FIGS. 3 and 4, during an initialization period P1, a low level of second scan signal SCAN2 and a low level of emission signal EM may be output. The second switching transistor ST2 and the fourth switching transistor ST4 may be turned on by the low level of second scan signal SCAN2 and the third switching transistor ST3 and the fifth switching transistor ST5 may be turned on by the low level of emission signal EM.

The first node N1 may be initialized to the reference voltage Vref through the turned-on third switching transistor ST3 and a voltage of the anode electrode of the light emitting diode ED may be initialized to the reference voltage Vref through the turned-on fourth switching transistor ST4.

Further, the driving transistor DT forms a diode connection through the turned-on second switching transistor ST2 to short the gate electrode and the drain electrode of the driving transistor DT so that the driving transistor DT may operate as a diode.

The reference voltage Vref which is transmitted to the anode electrode of the light emitting diode ED, that is, the fourth node N4, through the turned-on fourth switching transistor ST4 may be transmitted to the third node N3 and the second node N2 through the turned-on fifth switching transistor ST5. Therefore, the third node N3 and the second node N2 may be initialized to the reference voltage Vref.

Next, during a sampling period P2, the low level of first scan signal SCAN1 and the low level of second scan signal SCAN2 may be output, and the emission signal EM may be output at a high level. The third switching transistor ST3 is turned off by a high level of emission signal EM and the first switching transistor ST1 is turned on by the low level of first scan signal SCAN1, simultaneously, to transmit the data voltage Vdata to the first node N1.

The driving transistor DT is diode-connected by the turned-on second switching transistor ST2 and a different voltage of the high potential power voltage VDD and the threshold voltage is sampled to be supplied to the second node N2.

In some implementations, in the sampling period P2, the fifth switching transistor ST5 may be turned off by the high level of emission signal EM.

Next, in a holding period P3, the first scan signal SCAN1 and the second scan signal SCAN2 may be output at a high level and all the first switching transistor ST1, the second switching transistor ST2, and the fourth switching transistor ST4 may be turned off. However, even though the first switching transistor ST1 is turned off, the data voltage Vdata which has been input in the previous period (for example, a sampling period P2) may be maintained by the storage capacitor Cst.

Finally, the low level of emission signal EM may be output in the emission period P4. The reference voltage Vref is applied to the first node N1 through the third switching transistor ST3 which is turned on by the low level of emission signal EM and the voltage of the first node N1 may become the different voltage of the reference voltage Vref and the data voltage Vdata. Such voltage fluctuation may be reflected to the second node N2. The gate-source voltage of the driving transistor DT is set to a value Vdata−Vref+Vth obtained by subtracting the reference voltage Vref from the data voltage Vdata and then adding threshold voltage Vth to control the driving current.

The driving current from the driving transistor DT is supplied to the light emitting diode ED through the fifth switching transistor ST5 which is turned on by the low level of emission signal EM so that the light emitting diode ED may emit light.

FIG. 5 is a circuit diagram illustrating another example of a pixel included in a display device of FIG. 2.

In some implementations, pixel PX_1 illustrated in FIG. 5 represents another example of the pixel PX included in the display device 1000 which has been described with reference to FIG. 2. For example, as described with reference to FIGS. 1 and 2, when the display panel 100 is used for a vehicle which has been described with reference to FIG. 1 so that the display device 1000 is controlled to restrict a field of view of an image displayed in a specific region according to a driving mode, the pixel PX included in the display device 1000 may be implemented as a pixel PX_1 illustrated in FIG. 5.

In some implementations, the pixel PX_1 illustrated in FIG. 5 is a modified example for the pixel PX which has been described with reference to FIG. 3, with regard to the fourth switching transistor ST4_1, a selection circuit SLC, and a plurality of light emitting diodes ED1 and ED2 included in the pixel circuit PC_1. Accordingly, an identical description as the description of FIG. 3 will not be repeated.

Referring to FIG. 5, the pixel PX_1 according to the example implementation of the present disclosure may include a pixel circuit PC_1, a selection circuit SLC, and a plurality of light emitting diodes ED1 and ED2.

The pixel circuit PC_1 may include a driving transistor DT, a plurality of switching transistors ST1 to ST5, and a storage capacitor Cst.

A fourth switching transistor ST4_1 included in the pixel circuit PC_1 may include a first sub switching transistor ST4a and a second sub switching transistor ST4b.

The first sub switching transistor ST4a may apply the reference voltage Vref to the anode electrode of the first light emitting diode ED1. The first sub switching transistor ST4a may include a source electrode connected to the reference voltage line which supplies the reference voltage Vref, a drain electrode connected to the anode electrode of the first light emitting diode ED1, and a gate electrode connected to a second scan signal line to which a second scan signal SCAN2 is applied. The first sub switching transistor ST4a may be turned on or turned off by the second scan signal SCAN2. Therefore, the first sub switching transistor ST4a may apply the reference voltage Vref to the anode electrode of the first light emitting diode ED1 in response to the low level of second scan signal SCAN2 which is a turn-on level.

The second sub switching transistor ST4b may apply the reference voltage Vref to the anode electrode of the second light emitting diode ED2. The second sub switching transistor ST4b may include a source electrode connected to the reference voltage line which supplies the reference voltage Vref, a drain electrode connected to the anode electrode of the second light emitting diode ED2, and a gate electrode connected to a second scan signal line to which a second scan signal SCAN2 is applied. The second sub switching transistor ST4b may be turned on or turned off by the second scan signal SCAN2. Therefore, the second sub switching transistor ST4b may apply the reference voltage Vref to the anode electrode of the second light emitting diode ED2 in response to the low level of second scan signal SCAN2 which is a turn-on level.

Further, the fifth switching transistor ST5 may form a current path between the driving transistor DT and any one light emitting diode among the plurality of light emitting diodes ED1 and ED2. For example, the drain electrode of the fifth switching transistor ST5 is connected to the selection circuit SLC, for example, to the fourth node N4 so that the fifth switching transistor ST5 electrically connects the third node N3 and the fourth node N4, in response to the low level of emission signal EM which is a turn-on level. Therefore, a current path between the driving transistor DT and any one light emitting diode among the plurality of light emitting diodes ED1 and ED2 may be formed. The selection circuit SLC may include a plurality of selection transistors TP1 and TP2. The plurality of selection transistors TP1 and TP2 may include a first selection transistor TP1 and a second selection transistor TP2. The first selection transistor TP1 generates a current path of a first driving current which passes through the first light emitting diode ED1 and the second selection transistor TP2 generates a current path of a second driving current which passes through the second light emitting diode ED2.

The first selection transistor TP1 is connected between the fourth node N4 and the first light emitting diode ED1 and a gate electrode of the first selection transistor TP1 may be connected to a first selection signal line which supplies a first selection signal Ss. When a pixel PX_1, to which a pixel circuit PC_1 is applied, is driven in a first mode which is a wide field-of-view mode, the first selection signal Ss is supplied to the gate electrode of the first selection transistor TP1 to turn on the first selection transistor TP1. Therefore, a current path of the first driving current which passes through the first light emitting diode ED1 is formed so that the first light emitting diode ED1 may emit light. In some implementations, the first selection transistor TP1 may be referred to as a first emission control transistor which controls emission of the first light emitting diode ED1.

The second selection transistor TP2 is connected between the fourth node N4 and the second light emitting diode ED2 and a gate electrode of the second selection transistor TP2 may be connected to a second selection signal line which supplies a second selection signal Ps. When a pixel PX_1, to which a pixel circuit PC_1 is applied, is driven in a second mode which is a narrow field-of-view mode, the second selection signal Ps is supplied to the gate electrode of the second selection transistor TP2 to turn on the second selection transistor TP2. Therefore, a current path of the second driving current which passes through the second light emitting diode ED2 is formed so that the second light emitting diode ED2 may emit light. In some implementations, the second selection transistor TP2 may be referred to as a second emission control transistor which controls emission of the second light emitting diode ED2.

The first light emitting diode ED1 may be connected between the first selection transistor TP1 which is turned on or turned off by the first selection signal Ss and a low potential power line which supplies a low potential power voltage VSS. The second light emitting diode ED2 may be connected between the second selection transistor TP2 which is turned on or turned off by the second selection signal Ps and the low potential power line which supplies a low potential power voltage VSS.

In this case, the first light emitting diode ED1 or the second light emitting diode ED2 may be connected to another configuration of the pixel circuit PC_1, for example, the driving transistor DT, by the first selection transistor TP1 or the second selection transistor TP2 which is turned on according to a driving mode. For example, the first light emitting diode ED1 may be connected to the driving transistor DT via the first selection transistor TP1 which is turned on in the first mode and may supply light by the first driving current, in the first mode, that is, in the wide field-of-view mode at a wide viewing angle which is a first viewing angle. Further, the second light emitting diode ED2 may be connected to the driving transistor DT via the second selection transistor TP2 which is turned on in the second mode and may supply light by the second driving current, in the second mode, that is, in the narrow field-of-view mode at a narrow viewing angle which is a second viewing angle. In some implementations, the driving mode may be specified by the user's input or determined when a predetermined condition is satisfied.

FIGS. 6A and 6B are waveform charts for explaining an example of an operation of a pixel of FIG. 5.

FIG. 6A illustrates a waveform chart for explaining an example that the pixel PX_1 described with reference to FIG. 5 is driven in a first mode. FIG. 6B illustrates a waveform chart for explaining an example that the pixel PX_1 described with reference to FIG. 5 is driven in a second mode.

Referring to FIGS. 5 to 6B together, in the first mode, only the first light emitting diode ED1 may emit light and in the second mode, only the second light emitting diode ED2 may emit light. Here, as illustrated in FIG. 6A, the second selection signal Ps which controls the emission of the second light emitting diode ED2 to allow only the first light emitting diode ED1 to emit light in the first mode may be output only at a high level which is a turn-off level. Further, as illustrated in FIG. 6B, the first selection signal Ss which controls the emission of the first light emitting diode ED1 to allow only the second light emitting diode ED2 to emit light in the second mode may be output only at a high level (or first level) which is a turn-off level.

Specifically, the first mode which is a wide field-of-view mode will be described with reference to FIGS. 5 and 6A. In an initialization period P1, a low level of second scan signal SCAN2, a low level of first selection signal Ss, and a low level of emission signal EM may be output. The second switching transistor ST2, the first sub switching transistor ST4a, and the second sub switching transistor ST4b may be turned on by the low level of second scan signal SCAN2 and the first selection transistor TP1 may be turned on by the low level of first selection signal Ss. Further, the third switching transistor ST3 and the fifth switching transistor ST5 may be turned on by the low level of emission signal EM.

The first node N1 may be initialized to the reference voltage Vref through the turned-on third switching transistor ST3. A voltage of the anode electrode of the first light emitting diode ED1 and a voltage of the anode electrode of the second light emitting diode ED2 may be initialized to the reference voltage Vref through the turned-on first sub switching transistor ST4a and the turned-on second sub switching transistor ST4b.

Further, the driving transistor DT forms a diode connection through the turned-on second switching transistor ST2 to short the gate electrode and the drain electrode of the driving transistor DT so that the driving transistor DT may operate as a diode.

The reference voltage Vref which is transmitted to the anode electrode of the first light emitting diode ED1 through the turned-on first sub switching transistor ST4a is transmitted to the third node N3 and the second node N2 through the turned-on first selection transistor TP1 and the turned-on fifth switching transistor ST5. Therefore, the third node N3 and the second node N2 may be initialized to the reference voltage Vref.

Next, during the sampling period P2, the low level of first scan signal SCAN1 and the low level of second scan signal SCAN2 may be output and the first selection signal Ss may be output at a high level. A high level of emission signal EM is output to turn off the third switching transistor ST3 and the first switching transistor ST1 is turned on by the low level of first scan signal SCAN1, simultaneously, to transmit the data voltage Vdata to the first node N1. The driving transistor DT is diode-connected by the turned-on second switching transistor ST2 and a different voltage of the high potential power voltage VDD and the threshold voltage is sampled to be supplied to the second node N2.

In some implementations, during the sampling period P2, the fifth switching transistor ST5 may be turned off by the high level of emission signal EM and the first selection transistor TP1 may be turned off by the high level of first selection signal Ss.

Next, during a holding period P3, the first scan signal SCAN1 and the second scan signal SCAN2 are output at a high level and all the first switching transistor ST1, the second switching transistor ST2, the first sub switching transistor ST4a, and the second sub switching transistor ST4b may be turned off. However, even though the first switching transistor ST1 is turned off, the data voltage Vdata which has been input in the previous period (for example, a sampling period P2) may be maintained by the storage capacitor Cst.

Finally, during an emission period P4, the low level of first selection signal Ss and the low level of emission signal EM may be output and a high level of second selection signal Ps may be output. The reference voltage Vref is applied to the first node N1 through the third switching transistor ST3 which is turned on by the low level of emission signal EM and the voltage of the first node N1 may become the different voltage of the reference voltage Vref and the data voltage Vdata. Such voltage fluctuation may be reflected to the second node N2. The gate-source voltage of the driving transistor DT is set to a value Vdata−Vref+Vth obtained by subtracting the reference voltage Vref from the data voltage Vdata and then adding threshold voltage Vth to control the first driving current.

A first driving current is supplied from the driving transistor DT to the first light emitting diode ED1 through the fifth switching transistor ST5 which is turned on by the low level of emission signal EM and the first selection transistor TP1 which is turned on by the low level of first selection signal Ss. Therefore, the first light emitting diode ED1 may emit light. However, the second selection signal Ps is output at a high level to turn off the second selection transistor TP2 so that the second driving current from the driving transistor DT is not transmitted to the second light emitting diode ED2. Accordingly, when the pixel PX_1 is driven in the first mode, the first driving current is applied only to the first light emitting diode ED1 so that only the first light emitting diode ED1 may emit light.

Next, the second mode which is a narrow field-of-view mode will be described with reference to FIGS. 5 and 6B. Except that the first selection signal Ss and the second selection signal Ps are output in an opposite manner as in the first mode which is a wide field-of-view mode, the pixel PX_1 may be driven in the second mode, in a substantially same manner as in the first mode. That is, the first selection signal Ss may be output only at a high level which is a turn-off level and the second selection signal Ps may be output at a low level which is a turn-on level during the emission period P4 in which the second light emitting diode ED2 emits light.

Specifically, during the initial period P1, the first scan signal SCAN1 may be output at a high level and the second scan signal SCAN2 may be output at a low level. The first selection signal Ss may be output at a high level and the second selection signal Ps and the emission signal EM may be output at a low level. Therefore, the second switching transistor ST2, the first sub switching transistor ST4a, and the second sub switching transistor ST4b may be turned on by the second scan signal SCAN2 and the second selection transistor TP2 may be turned on by the second selection signal Ps. Further, the third switching transistor ST3 and the fifth switching transistor ST5 may be turned on by the emission signal EM.

The first node N1 may be initialized to the reference voltage Vref through the third switching transistor ST3 which is turned on by the emission signal EM. The anode electrodes of the first light emitting diode ED1 and the second light emitting diode ED2 may be initialized to the reference voltage Vref by the first sub switching transistor ST4a and the second sub switching transistor ST4b which are turned on by the second scan signal SCAN2. The driving transistor DT is diode-connected through the turned-on second switching transistor ST2 to operate as a diode. Finally, the reference voltage Vref which is transmitted to the anode electrode of the second light emitting diode ED2 through the turned-on second sub switching transistor ST4b is transmitted to the third node N3 and the second node N2 through the turned-on second selection transistor TP2 and the turned on fifth switching transistor ST5. Therefore, the third node N3 and the second node N2 may be initialized to the reference voltage Vref.

Next, during the sampling period P2, the low level of first scan signal SCAN1 and the low level of second scan signal SCAN2 may be output and the second selection signal Ps and the emission signal EM may be output at a high level from the low level. A high level of emission signal EM is output to turn off the third switching transistor ST3 and the first switching transistor ST1 is turned on by the low level of first scan signal SCAN1 to transmit the data voltage Vdata to the first node N1. The driving transistor DT is diode-connected by the turned-on second switching transistor ST2 and a different voltage of the high potential power voltage VDD and the threshold voltage is sampled to be supplied to the second node N2.

In some implementations, in the sampling period P2, the fifth switching transistor ST5 may be turned off by the high level of emission signal EM and the second selection transistor TP2 may be turned off by the high level of second selection signal Ps.

Finally, during the emission period P4, the low level of second selection signal Ps and the low level of emission signal EM may be output and a high level of first selection signal Ss may be output. The reference voltage Vref is applied to the first node N1 through the third switching transistor ST3 which is turned on by the low level of emission signal EM and the voltage of the first node N1 may become the different voltage of the reference voltage Vref and the data voltage Vdata. Such voltage fluctuation may be reflected to the second node N2. The gate-source voltage of the driving transistor DT is set to a value Vdata−Vref+Vth obtained by subtracting the reference voltage Vref from the data voltage Vdata and then adding threshold voltage Vth to control the second driving current.

A second driving current is supplied from the driving transistor DT to the second light emitting diode ED2 through the fifth switching transistor ST5 which is turned on by the low level of emission signal EM and the second selection transistor TP2 which is turned on by the low level of second selection signal Ps. Therefore, the second light emitting diode ED2 may emit light. However, the first selection signal Ss is output at a high level to turn off the first selection transistor TP1 so that the first driving current from the driving transistor DT is not transmitted to the first light emitting diode ED1. Accordingly, when the pixel PX_1 is driven in the second mode, the second driving current is applied only to the second light emitting diode ED2 so that only the second light emitting diode ED2 may emit light.

FIGS. 7 and 8 are cross-sectional views illustrating a part of a display device according to example implementations of the present disclosure.

In particular, FIGS. 7 and 8 illustrate examples of a cross-sectional structure of a display device 1000 when a display panel 100 is used for a vehicle (e.g., as described with reference to FIG. 1) so that the display device 1000 is controlled to restrict a field of view of an image displayed in a specific region according to a driving mode (as described with reference to FIGS. 1 and 2, respectively). For example, FIG. 7 illustrates a cross-sectional structure of a display device 1000 including a pixel (for example, a pixel PX_1 of FIG. 5) in which a first optical member 161 is disposed. FIG. 8 illustrates a cross-sectional structure of a display device 1000 including a pixel (for example, a pixel PX_1 of FIG. 5) in which a second optical member 162 is disposed.

Referring to FIGS. 7 and 8, the display device 1000 according to the example implementation of the present disclosure may include a substrate 110, a buffer film 111, a gate insulating film 112, an interlayer insulating film 113, a lower protection film 114, an overcoat layer 115, a bank insulating film 116, a first selection transistor TP1, a second selection transistor TP2, a first light emitting diode ED1, a second light emitting diode ED2, a first optical member 161, a second optical member 162, an optical member protection film 170, and an encapsulation member 180.

The substrate 110 may include an insulating material. The substrate 110 may include a transparent material. For example, the substrate 110 may include glass or plastic.

The buffer film 111 may be disposed on the substrate 110. The buffer film 111 may include an insulating material. For example, the buffer film 111 may include an inorganic insulating material, such as silicon oxide (SiOx) or silicon nitride (SiNx). The buffer film 111 may have a multi-layered structure. For example, the buffer film 111 may have a laminated structure of a film formed of silicon nitride (SiNx) and a film formed of silicon oxide (SiOx).

The buffer film 111 may be located between the substrate 110 and a driving part of each pixel PX. The buffer film 111 may suppress the contamination due to the substrate 110 in a process of forming the driving part. For example, a top surface of the substrate 110 which is directed to the driving part of each pixel PX_1 may be covered by the buffer film 111. The driving part of each pixel PX_1 may be located on the buffer film 111.

The gate insulating film 112 may be disposed on the buffer film 111. The gate insulating film 112 may include an insulating material. For example, the gate insulating film 112 may include an inorganic insulating material, such as silicon oxide (SiO) or silicon nitride (SiN). The gate insulating film 112 may include a material having a high permittivity. For example, the gate insulating film 112 may include a High-K material, such as hafnium oxide (HfO). The gate insulating film 112 may have a multi-layered structure.

The gate insulating film 112 may extend between the semiconductor layers 121 and 221 of the selection transistors TP1 and TP2 and the gate electrodes 122 and 223. For example, gate electrodes of the driving transistor and the switching transistor may be insulated from semiconductor layers of the driving transistor and the switching transistor by the gate insulating film 112. The gate insulating film 112 may cover the semiconductor layer of each pixel PX_1. The gate electrodes of the driving transistor and the switching transistor may be located on the gate insulating film 112.

The interlayer insulating film 113 may be disposed on the gate insulating film 112. The interlayer insulating film 113 may include an insulating material. For example, the interlayer insulating film 113 may include an inorganic insulating material, such as silicon oxide (SiO) or silicon nitride (SiN). The interlayer insulating film 113 may extend between the gate electrode and the source electrode of each of the driving transistor and the switching transistor and between the gate electrode and the drain electrode. For example, the source electrode and the drain electrode of each of the driving transistor and the switching transistor may be insulated from the gate electrode by the interlayer insulating film 113. The interlayer insulating film 113 may cover the gate electrode of each of the driving transistor and the switching transistor. The source electrode and the drain electrode of each pixel PX_1 may be located on the interlayer insulating film 113. The gate insulating film 112 and the interlayer insulating film 113 may expose a source region and a drain region of each semiconductor pattern which is located in each pixel PX_1.

The lower protection film 114 may be disposed on the interlayer insulating film 113. The lower protection film 114 may include an insulating material. For example, the lower protection film 114 may include an inorganic insulating material, such as silicon oxide (SiO) or silicon nitride (SiN). The lower protection film 114 may suppress the damage of the driving part due to the external moisture and shocks. The lower protection film 114 may extend along surfaces of the driving transistor and the switching transistor which are opposite to the substrate 110. The lower protection film 114 may be in contact with the interlayer insulating film 113 at the outside of the driving part located in each pixel PX_1.

The overcoat layer 115 may be disposed on the lower protection film 114. The overcoat layer 115 may include an insulating material. The overcoat layer 115 may include a material different from that of the lower protection film 114. For example, the overcoat layer 115 may include an organic insulating material. The overcoat layer 115 may remove a step caused by the driving part of each pixel PX_1. For example, a top surface of the overcoat layer 115 which is opposite to the substrate 110 may be a flat surface.

The first selection transistor TP1 and the second selection transistor TP2 may be disposed on the substrate 110. The first selection transistor TP1 may be electrically connected between the drain electrode of the driving transistor DT and the first lower electrode 141 of the first light emitting diode ED1. The second selection transistor TP2 may be electrically connected between the drain electrode of the driving transistor DT and the second lower electrode 151 of the second light emitting diode ED2.

The first selection transistor TP1 may include a first semiconductor layer 121, a first gate electrode 122, a first source electrode 123, and a first drain electrode 124. The first selection transistor TP1 may have the same structure as the switching transistor and the driving transistor. For example, the first semiconductor layer 121 may be located between the buffer film 111 and the gate insulating film 112 and the first gate electrode 122 may be located between the gate insulating film 112 and the interlayer insulating film 113. The first source electrode 123 and the first drain electrode 124 may be located between the interlayer insulating film 113 and the lower protection film 114. The first gate electrode 122 may overlap a channel region of the first semiconductor layer 121. The first source electrode 123 may be electrically connected to the source region of the first semiconductor layer 121. The first drain electrode 124 may be electrically connected to the drain region of the first semiconductor layer 121.

The second selection transistor TP2 may include a second semiconductor layer 221, a second gate electrode 223, a second source electrode 225, and a second drain electrode 227. For example, the second semiconductor layer 221 may be located on the same layer as the first semiconductor layer 121 and the second gate electrode 223 may be located on the same layer as the first gate electrode 122. The second source electrode 225 and the second drain electrode 227 may be located on the same layer as the first source electrode 123 and the first drain electrode 124.

The first light emitting diode ED1 and the second light emitting diode ED2 of each pixel PX_1 may be disposed on the overcoat layer 115 of the corresponding pixel PX_1.

The first light emitting diode ED1 may emit light representing a specific color. For example, the first light emitting diode ED1 may include a first lower electrode 141, a first emission layer 142, and a first upper electrode 143 which are sequentially laminated on the substrate 110.

The first lower electrode 141 may include a conductive material. The first lower electrode 141 may include a material having a high reflectance. For example, the first lower electrode 141 may include metal, such as aluminum (Al), and silver (Ag). The first lower electrode 141 may have a multi-layered structure. For example, the first lower electrode 141 may have a structure in which a reflective electrode formed of a metal is located between transparent electrodes formed of a transparent conductive material, such as ITO and IZO. The first lower electrode 141 may be electrically connected to the first drain electrode 124 of the first selection transistor TP1 through a contact hole which passes through the lower protection film 114 and the overcoat layer 115.

The first emission layer 142 may generate light with luminance corresponding to a voltage difference between the first lower electrode 141 and the first upper electrode 143. For example, the first emission layer 142 may include an emission material layer (EML) including an emission material. The emission material may include an organic material, an inorganic material, or a hybrid material.

The first emission layer 142 may have a multi-layered structure. For example, the first emission layer 142 may further include at least one of a hole injection layer HIL, a hole transport layer HTL, an electron transport layer ETL, and an electron injection layer EIL.

The first upper electrode 143 may include a conductive material. The first upper electrode 143 may include a different material from that of the first lower electrode 141. A transmittance of the first upper electrode 143 may be higher than a transmittance of the first lower electrode 141. For example, the first upper electrode 143 may be a transparent electrode formed of a transparent conductive material, such as ITO and IZO. Accordingly, in the display device 1000 according to the example implementation of the present disclosure, light generated by the first emission layer 142 may be emitted through the first upper electrode 143.

The second light emitting diode ED2 may implement the same color as the first light emitting diode ED1. The second light emitting diode ED2 may have the same structure as the first light emitting diode ED1. For example, the second light emitting diode ED2 may include a second lower electrode 151, a second emission layer 152, and a second upper electrode 153 which are sequentially laminated on the substrate 110.

The second lower electrode 151 may correspond to the first lower electrode 141, the second emission layer 152 may correspond to the first emission layer 142, and the second upper electrode 153 may correspond to the first upper electrode 143. For example, the second lower electrode 151 may be formed for the second light emitting diode ED2 with the same structure as the first lower electrode 141 and this is the same for the second emission layer 152 and the second upper electrode 153. For example, the first light emitting diode ED1 and the second light emitting diode ED2 may be formed to have the same structure. However, it is not limited thereto and in some cases, at least a partial configuration of the first light emitting diode ED1 and the second light emitting diode ED2 may be formed to be different.

The second emission layer 152 may be spaced apart from the first emission layer 142. Accordingly, the emission due to the leakage current may be suppressed.

According to the example implementation, light may be generated by only one of the first emission layer 142 and the second emission layer 152 by the user's choice or according to a predetermined condition.

The second lower electrode 151 of each pixel PX_1 may be spaced apart from the first lower electrode 141 of the corresponding pixel PX_1. For example, the bank insulating film 116 may be located between a first lower electrode 141 and a second lower electrode 151 of each pixel PX_1. The bank insulating film 116 may include an insulating material. For example, the bank insulating film 116 may include an organic insulating material. The bank insulating film 116 may include a material different from that of the overcoat layer 115.

The second lower electrode 151 of each pixel PX_1 may be insulated from the first lower electrode 141 of the corresponding pixel PX_1 by the bank insulating film 116. For example, the bank insulating film 116 may cover an edge of the first lower electrode 141 and an edge of the second lower electrode 151 located in each pixel PX_1. Accordingly, in the display device 1000, an image by a first optical area of each pixel PX_1 in which the first light emitting diode ED1 is located and an image by a second optical area of the corresponding pixel PX_1 in which the second light emitting diode ED2 is located may be provided to the user.

The first emission layer 142 and the first upper electrode 143 of the first light emitting diode ED1 located in each pixel PX_1 may be laminated on a partial area of the first lower electrode 141 exposed by the bank insulating film 116. The second emission layer 152 and the second upper electrode 153 of the second light emitting diode ED2 located in each pixel PX_1 may be laminated on a partial area of the second lower electrode 151 exposed by the bank insulating film 116. For example, the bank insulating film 116 may divide a first emission area in which light by the first light emitting diode ED1 is emitted and a second emission area in which light by the second light emitting diode ED2 is emitted in each pixel PX_1. A size of the second emission area which is divided in the pixel PX_1 may be smaller than a size of the first emission area.

The second upper electrode 153 of each pixel PX_1 may be electrically connected to the first upper electrode 143 of the corresponding pixel PX_1. For example, a voltage applied to the second upper electrode 153 of the second light emitting diode ED2 located in each pixel PX_1 may be equal to a voltage applied to the first upper electrode 143 of the first light emitting diode ED1 located in the pixel PX_1. The second upper electrode 153 of each pixel PX_1 may include the same material as the first upper electrode 143 of the corresponding pixel PX_1. For example, the second upper electrode 153 of each pixel PX_1 may be formed simultaneously with the first upper electrode 143 of the corresponding pixel PX_1. The second upper electrode 153 of each pixel PX_1 extends onto the bank insulating film 116 to be in direct contact with the first upper electrode 143 of the corresponding pixel PX_1. A luminance of a first optical area and a luminance of a second optical area located in each pixel PX_1 may be controlled by a driving current generated in the corresponding pixel PX_1.

The encapsulation member 180 may be located on the first light emitting diode ED1 and the second light emitting diode ED2 of each pixel PX_1. The encapsulation member 180 may suppress the damage of the plurality of light emitting diodes ED1 and ED2 due to moisture and shocks from the outside. The encapsulation member 180 may have a multi-layered structure. For example, the encapsulation member 180 may include a first encapsulation layer 181, a second encapsulation layer 182, and a third encapsulation layer 183 which are sequentially laminated, but it is not limited thereto. The first encapsulation layer 181, the second encapsulation layer 182, and the third encapsulation layer 183 may include an insulating material. The second encapsulation layer 182 may include a material different from that of the first encapsulation layer 181 and the third encapsulation layer 183. For example, the first encapsulation layer 181 and the third encapsulation layer 183 are inorganic encapsulation layers including an inorganic insulating material and the second encapsulation layer 182 may include an organic encapsulation layer including an organic insulating material. Therefore, the plurality of light emitting diodes ED1 and ED2 may efficiently suppress the damage due to the moisture and shocks from the outside.

The first optical member 161 and the second optical member 162 may be disposed on the encapsulation member 180.

The first optical member 161 may be disposed on the first light emitting diode ED1. Light which is generated by the first light emitting diode ED1 of each pixel PX_1 may be emitted through the first optical member 161 which is disposed in the first optical area of the corresponding pixel PX_1. The first optical member 161 may have a shape that does not limit light of at least one direction. For example, a planar shape of the first optical member 161 located in each pixel PX_1 may have a bar shape extending in one direction.

In this case, a traveling direction of the light emitted from the first optical area of each pixel PX_1 may not be restricted to one direction. For example, contents (or images) provided through the first optical area of each pixel PX_1 may be shared by surrounding people who are adjacent to the user in one direction. Accordingly, the contents provided by the light emitted through the first optical member 161 may be provided in a first viewing angle range which is larger than a viewing angle of contents provided by the light emitted through the second optical member 162. For example, the content provided by the light emitted through the first optical member 161 may be provided in a wide field-of-view mode (share mode).

The second optical member 162 may be disposed on the second light emitting diode ED2. Light which is generated by the second light emitting diode ED2 of each pixel PX_1 may be emitted through the second optical member 162 which is disposed in the second optical area of the corresponding pixel PX_1. The second optical member 162 may restrict a traveling direction of passing light in one direction and/or the other direction. For example, a planar shape of the second optical member 162 located in each pixel PX_1 may be a circle.

In this case, a traveling direction of the light emitted from the second optical area of each pixel PX_1 may be limited to one direction and/or the other direction. For example, contents (or images) provided by the second optical area of each pixel PX_1 may not be shared by surrounding people of the user. Accordingly, the contents provided by the light emitted through the second optical member 162 may be provided in a second viewing angle range which is smaller than a viewing angle of contents provided by the light emitted through the first optical member 161. For example, the content provided by the light emitted through the second optical member 162 may be provided in a narrow field-of-view mode (private mode).

The first emission area of each pixel PX_1 may have a shape corresponding to the first optical member 161 of the corresponding pixel PX_1. For example, a planar shape of the first emission area of each pixel PX_1 may have a bar shape which extends in one direction. The first optical member 161 may have a size larger than the first emission area of the corresponding pixel PX_1. Accordingly, the efficiency of light discharged from the first emission area of the pixel PX_1 may be improved.

The second emission area of each pixel PX_1 may have a shape corresponding to the second optical member 162 of the corresponding pixel PX_1. For example, a planar shape of the second emission area of each pixel PX_1 may be a circle. The second optical member 162 may have a size larger than the second emission area of the corresponding pixel PX_1. Accordingly, the efficiency of light discharged from the second emission area of the pixel PX_1 may be improved.

An optical member protection film 170 may be located on the first optical member 161 and the second optical member 162 of the pixel PX_1. The optical member protection film 170 may include an insulating material. For example, the optical member protection film 170 may include an organic insulating material. A refractive index of the optical member protection film 170 may be smaller than a refractive index of the first optical member 161 and a refractive index of the second optical member 162 located in each pixel PX_1. Accordingly, light which passes through the first optical member 161 and the second optical member 162 of each pixel PX_1 may not be reflected toward the substrate 110 due to the refractive index difference from the optical member protection film 170.

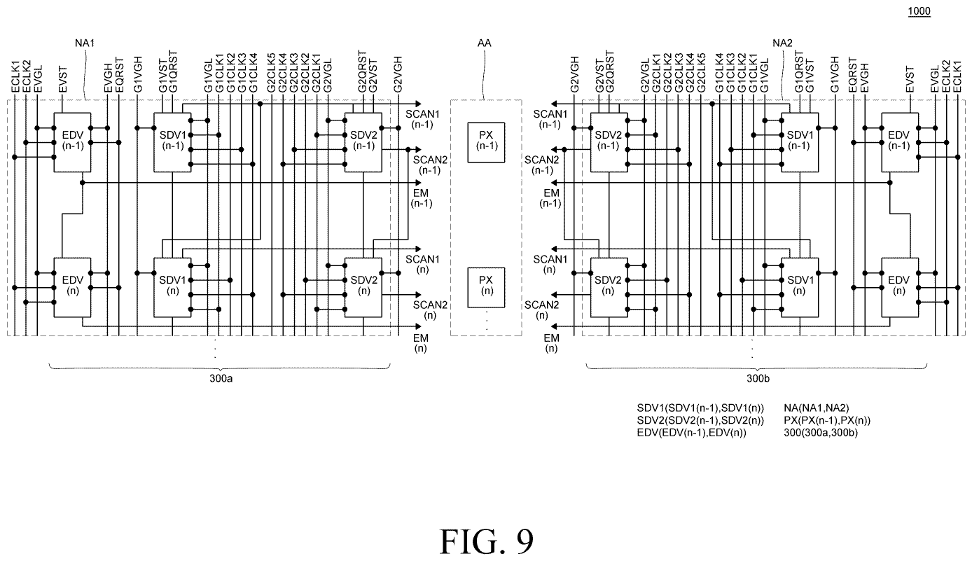

FIG. 9 is a view for explaining an example of a placement structure of a gate driver included in a display device of FIG. 2.

Referring to FIGS. 2 and 9, the display device 1000 according to the example implementation of the present disclosure may include the plurality of pixels PX disposed in the active area AA and the gate driver 300 disposed in the non-active area NA.

In the example implementation, as described with reference to FIG. 2, the gate driver 300 may be embedded on the non-active area NA of the display panel 100 in a GIP manner. For example, the gate driver 300 may include a first gate driver 300a disposed in the first non-active area NA1 located on one side of the active area AA, in the non-active area NA and a second gate driver 300b located in a second non-active area NA2 located in the other side of the active area AA. Accordingly, the first gate driver 300a and the second gate driver 300b supply the gate signal to the plurality of pixels PX disposed in the active area AA on both sides of the active area AA so that the voltage drop (IR drop) according to the load of the display panel 100 may be improved.

The gate driver 300, for example, the first gate driver 300a and the second gate driver 300b may supply the scan signal and the emission signal to the plurality of pixels PX disposed in the active area AA, respectively. For example, each of the first gate driver 300a and the second gate driver 300b may include a first scan driver SDV1 which outputs a first scan signal SCAN1, a second scan driver SDV2 which outputs a second scan signal SCAN2, and an emission signal driver EDV which outputs an emission signal EM.

According to the example implementation, the second scan driver SDV2 may be disposed on the non-active area NA, for example, a non-active area NA which is the most adjacent to the active area AA, between the first non-active area NA1 and the second non-active area NA2. The emission driver EDV may be disposed in a non-active area NA which is the furthest from the active area AA. However, this is just an example so that the implementations of the present disclosure are not limited thereto.

The first scan driver SDV1 may supply the first scan signal SCAN1 to the plurality of pixels PX based on a first scan start signal G1VST (or a first scan signal output from a previous stage), a first scan reset signal G1QRST, first to fourth gate clock signals G1CLK1 to G1CLK4, a first gate power G1VGH, and a second gate power G1VGL. For example, the first scan driver SDV1 may sequentially output the first scan signal SCAN1 in a unit of pixel rows.

For example, an n−1-th (n is an integer larger than 1) stage (denoted by “SDV1(n−1)” in FIG. 9) of the first scan driver SDV1 may supply a first scan signal SCAN1(n−1) to a pixel (denoted by “PX(n−1)” in FIG. 9) disposed in an n−1-th row, among the plurality of pixels PX. An n-th stage (denoted by “SDV1(n)” in FIG. 9) of the first scan driver SDV1 may supply a first scan signal SCAN1(n) to a pixel (denoted by “PX(n)” in FIG. 9) disposed in an n-th row, among the plurality of pixels PX.

The second scan driver SDV2 may supply the second scan signal SCAN2 to the plurality of pixels PX based on a second scan start signal G2VST (or a second scan signal output from a previous stage), a second scan reset signal G2QRST, first to fifth gate clock signals G2CLK1 to G2CLK5, a third gate power G2VGH, and a fourth gate power G2VGL. For example, the second scan driver SDV2 may sequentially output the second scan signal SCAN2 in a unit of pixel rows.

For example, an n−1-th stage (denoted by “SDV2(n−1)” in FIG. 9) of the second scan driver SDV2 may supply a second scan signal SCAN2(n−1) to a pixel (denoted by “PX(n−1)” in FIG. 9) disposed in an n−1-th row, among the plurality of pixels PX. An n-th stage (denoted by “SDV2(n)” in FIG. 9) of the second scan driver SDV2 may supply a second scan signal SCAN2(n) to a pixel (denoted by “PX(n)” in FIG. 9) disposed in an n-th row, among the plurality of pixels PX.

The emission signal driver EDV may supply the emission signal EM to the plurality of pixels PX, based on an emission start signal EVST (or an emission signal output from a previous stage), an emission reset signal EQRST, first and second emission clock signals ECLK1 and ECLK2, a fifth gate power EVGH, and a sixth gate power EVGL. For example, the emission signal driver EDV may sequentially output the emission signal EM in the unit of pixel rows.

For example, an n−1-th stage (denoted by “EDV(n−1)” in FIG. 9) of the emission signal driver EDV may supply an emission signal EM(n−1) to a pixel (denoted by “PX(n−1)” in FIG. 9) disposed in an n−1-th row, among the plurality of pixels PX. An n-th stage (denoted by “EDV(n)” in FIG. 9) of the emission signal driver EDV may supply an emission signal EM(n) to a pixel (denoted by “PX(n)” in FIG. 9) disposed in an n-th row, among the plurality of pixels PX.

According to the example implementation, the first gate power G1VGH supplied to the first scan driver SDV1, the third gate power G2VGH supplied to the second scan driver SDV2, and the fifth gate power EVGH supplied to the emission signal driver EDV may have the same power voltage, for example, a positive voltage level. Further, the second gate power G1VGL supplied to the first scan driver SDV1, the fourth gate power G2VGL supplied to the second scan driver SDV2, and the sixth gate power EVGL supplied to the emission signal driver EDV may have the same power voltage, for example, a negative voltage level. However, the present disclosure is not limited thereto.

In the example implementation, various signal lines for driving the first scan driver SDV1, the second scan driver SDV2, and the emission signal driver EDV which have been described above may include a metal material. For example, the signal lines for driving the first scan driver SDV1, the second scan driver SDV2, and the emission signal driver EDV are disposed on the same layer as source electrodes and the drain electrodes of the transistors (for example, the driving transistor DT, the plurality of switching transistors ST1 to ST5, and/or the plurality of selection transistors TP1 and TP2) which are included in the pixels PX and PX_1 described with reference to FIGS. 3 and 5. Further, the signal lines may include the same material as the source electrodes and the drain electrodes. For example, the signal lines for driving the first scan driver SDV1, the second scan driver SDV2, and the emission signal driver EDV may be disposed on the same layer and include the same material as the first source electrode 123 and the first drain electrode 124 of the first selection transistor TP1, the second source electrode 225 and/or the second drain electrode 227 of the second selection transistor TP2 described with reference to FIGS. 7 and 8. For example, the corresponding signal lines may have a laminated structure (Ti/Al/Ti) of titanium (Ti) and aluminum (Al), but this is just an example and implementations of the present disclosure are not limited thereto.

According to the example implementation, various signal lines for driving the first scan driver SDV1, the second scan driver SDV2, and the emission signal driver EDV may be disposed on the same layer as the source electrode and/or the drain electrode of the transistor as described above. However, in order to suppress the shorts between wiring lines, the signal lines may be electrically connected to a connection pattern (or a connection line) which is disposed on a different layer through at least one contact hole in an area where signal lines overlap. For example, the connection pattern may be disposed on the same layer and include the same material as the gate electrode of the transistor which is included in the pixels PX and PX_1 described with reference to FIGS. 3 and 5 (for example, the driving transistor DT, the plurality of switching transistors ST1 to ST5, and/or the plurality of selection transistors TP1 and TP2), but is not limited thereto.

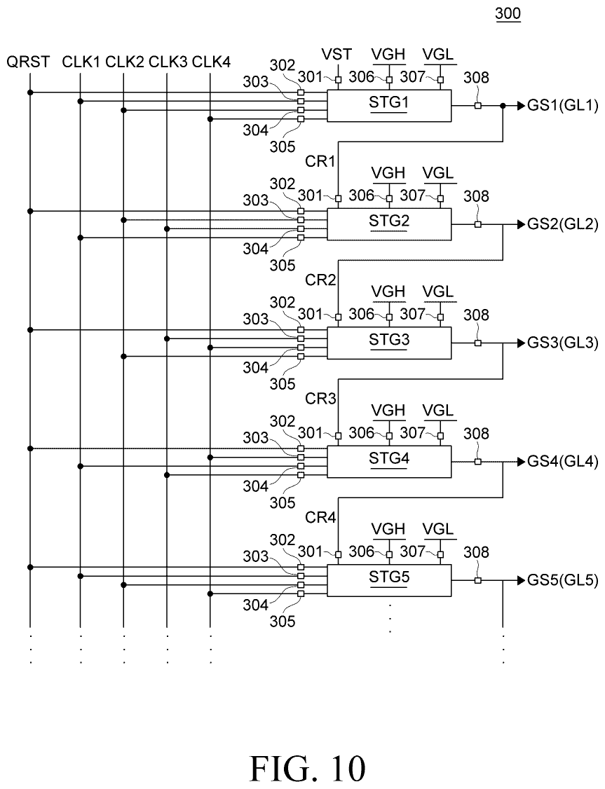

FIG. 10 is a block diagram illustrating a gate driver according to example implementations of the present disclosure.

For example, FIG. 10 illustrates an example of the gate driver 300 included in the display device 1000 according to the example implementation of the present disclosure which has been described with reference to FIG. 2.

For the convenience of description, in FIG. 10, five stages STG1 to STG5 included in the gate driver 300 and a plurality of gate signals GS1 to GS5 output therefrom are illustrated, but implementations are not limited to any specific number of stages.

According to the example implementation, the plurality of stages STG1 to STG5 illustrated in FIG. 10 may correspond to a plurality of stages included in any one driver of the first scan driver SDV1 and the second scan driver SDV2 included in the gate driver 300 which has been described with reference to FIG. 9. For example, the plurality of stages STG1 to STG5 illustrated in FIG. 10 may correspond to a plurality of stages included in the first scan driver SDV1. For example, the start signal VST, the reset signal QRST, the first to fourth clock signals CLK1 to CLK4, the first power source VGH, and the second power source VGL illustrated in FIG. 10 may correspond to the first scan start signal G1VST, the first scan reset signal G1QRST, the first to fourth gate clock signals G1CLK1 to G1CLK4, the first gate power G1VGH, and the second gate power G1VGL which have been described with reference to FIG. 9. However, this is just example so that the example implementation of the present disclosure is not limited thereto.

Referring to FIG. 10, the gate driver 300 may include a plurality of stages STG1 to STG5. The plurality of stages STG1 to STG5 may be connected to corresponding gate lines GL1 to GL5 and output gate signals GS1 to GS5 based on the first to fourth clock signals CLK1 to CLK4.

In one example implementation, the plurality of stages STG1 to STG5 included in the gate driver 300 may be cascaded.

For example, the second stage STG2 may be cascaded to the first stage STG1, the third stage STG3 may be cascaded to the second stage STG2, the fourth stage STG4 may be cascaded to the third stage STG3, and the fifth stage STG5 may be cascaded to the fourth stage STG4. Here, the plurality of stages STG1 to STG5 may have the substantially same configuration.

Each of the stages STG1 to STG5 may include a first input terminal 301, a second input terminal 302, a third input terminal 303, a fourth input terminal 304, a fifth input terminal 305, a first power input terminal 306, a second power input terminal 307, and an output terminal 308.

The first input terminal 301 of each of the plurality of stages STG1 to STG5 may receive an input signal. For example, the first input terminal 301 of the first stage STG1 may receive a start signal VST. Further, the first input terminal 301 of each of second to fifth stages STG2 to STG5 may receive any one of carry signals, for example, any one of first to fourth carry signals CR1 to CR4 output from the output terminal 308 of a previous stage. For example, the first input terminal 301 of the second stage STG2 may receive a first carry signal CR1 output from the output terminal 308 of the first stage STG1. The first input terminal 301 of the third stage STG3 may receive a second carry signal CR2 output from the output terminal 308 of the second stage STG2. The first input terminal 301 of the fourth stage STG4 may receive a third carry signal CR3 output from the output terminal 308 of the third stage STG3. The first input terminal 301 of the fifth stage STG5 may receive a fourth carry signal CR4 output from the output terminal 308 of the fourth stage STG4.

The second input terminal 302 of each of the plurality of stages STG1 to STG5 may receive a reset signal QRST. Here, the reset signal controls a signal level of a gate signal output through the output terminal 308 of respective stages STG1 to STG5. When the reset signal QRST is applied to a stage, a voltage level of nodes which are included in the corresponding stage and control a signal level of the output terminal 308 may be controlled.

Three clock signals, among the first to fourth clock signals CLK1 to CLK4, may be supplied to the third to fifth input terminals 303, 304, and 305 of each of the plurality of stages STG1 to STG5. For example, one of the first to fourth clock signals CLK1 to CLK4 may be supplied to each of the third to fifth input terminals 303, 304, and 305 of each of the plurality of stages STG1 to STG5.

In one example implementation, a third input terminal 303 of a k-th (k is an integer larger than 0) stage may receive the first clock signal CLK1. A third input terminal 303 of a k+1-th stage may receive the second clock signal CLK2 and a third input terminal 303 of a k+2-th stage may receive the third clock signal CLK3. A third input terminal 303 of a k+3-th stage may receive the fourth clock signal CLK4 and a third input terminal 303 of a k+4-th stage may receive the first clock signal CLK1.

For example, a third input terminal 303 of a first stage STG1 may receive the first clock signal CLK1. A third input terminal 303 of a second stage STG2 may receive the second clock signal CLK2 and a third input terminal 303 of a third stage STG3 may receive the third clock signal CLK3. A third input terminal 303 of a fourth stage STG4 may receive the fourth clock signal CLK4 and a third input terminal 303 of a fifth stage STG5 may receive the first clock signal CLK1.

In one example implementation, a fourth input terminal 304 of the k-th stage may receive the second clock signal CLK2. A fourth input terminal 304 of the k+1-th stage may receive the third clock signal CLK3 and a fourth input terminal 304 of the k+2-th stage may receive the fourth clock signal CLK4. A fourth input terminal 304 of the k+3-th stage may receive the first clock signal CLK1 and a fourth input terminal 304 of the k+4-th stage may receive the second clock signal CLK2.

For example, a fourth input terminal 304 of a first stage STG1 may receive the second clock signal CLK2. A fourth input terminal 304 of a second stage STG2 may receive the third clock signal CLK3 and a fourth input terminal 304 of a third stage STG3 may receive the fourth clock signal CLK4. A fourth input terminal 304 of a fourth stage STG4 may receive the first clock signal CLK1 and a fourth input terminal 304 of a fifth stage STG5 may receive the second clock signal CLK2.

In one example implementation, a fifth input terminal 305 of the k-th stage may receive the fourth clock signal CLK4. A fifth input terminal 305 of the k+1-th stage may receive the first clock signal CLK1 and a fifth input terminal 305 of the k+2-th stage may receive the second clock signal CLK2. A fifth input terminal 305 of the k+3-th stage may receive the third clock signal CLK3 and a fifth input terminal 305 of the k+4-th stage may receive the fourth clock signal CLK4.

For example, a fifth input terminal 305 of a first stage STG1 may receive the fourth clock signal CLK4. A fifth input terminal 305 of a second stage STG2 may receive the first clock signal CLK1 and a fifth input terminal 305 of a third stage STG3 may receive the second clock signal CLK2. A fifth input terminal 305 of a fourth stage STG4 may receive the third clock signal CLK3 and a fifth input terminal 305 of a fifth stage STG5 may receive the fourth clock signal CLK4.

The first to fourth clock signals CLK1 to CLK4 may have the same cycle and have a waveform in which phases do not overlap each other. For example, the second clock signal CLK2 may be set as a signal which is shifted by an approximately quarter cycle from the first clock signal CLK1. The third clock signal CLK3 may be set as a signal which is shifted by an approximately quarter cycle from the second clock signal CLK2. The fourth clock signal CLK4 may be set as a signal which is shifted by an approximately quarter cycle from the third clock signal CLK3.

Voltages of power sources required to drive the plurality of stages STG1 to STG5 may be applied to the first and second power input terminals 306 and 307 of the plurality of stages STG1 to STG5.

For example, a voltage of the first power source VGH may be applied to the first power input terminal 306 of each of the plurality of stages STG1 to STG5 and a voltage of the second power source VGL may be applied to the second power input terminal 307 of each of the plurality of stages STG1 to STG5. A voltage of the first power source VGH and a voltage of the second power source VGL may have a DC voltage level. Here, a voltage level of the first power source VGH may be set to be higher than a voltage level of the second power source VGL.

Gate signals GS1 to GS5 may be output to the output terminals 308 of each of the plurality of stages STG1 to STG5. In one example implementation, the plurality of gate signals GS1 to GS5 output to the respective output terminals 308 may be supplied to corresponding gate lines GL1 to GL5.

Further, the plurality of gate signals GS1 to GS5 output to the output terminals 308 of the plurality of stages STG1 to STG5 may be supplied to the first input terminal 301 of each subsequent stage as a plurality of carry signals CR1 to CR5. For example, a first carry signal CR1 output from the output terminal 308 of the first stage STG1 may be supplied to the first input terminal 301 of the second stage STG2. A second carry signal CR2 output from the output terminal 308 of the second stage STG2 may be supplied to the first input terminal 301 of the third stage STG3. A third scan carry signal CR3 output from the output terminal 308 of the third stage STG3 may be supplied to the first input terminal 301 of the fourth stage STG4. A fourth scan carry signal CR4 output from the output terminal 308 of the fourth stage STG4 may be supplied to the first input terminal 301 of the fifth stage STG5.

In one example implementation, the plurality of stages STG1 to STG5 included in the gate driver 300 may have the substantially same configuration, except a type of a signal which is received through the first input terminal 301. For example, the first stage STG1 which is an initial stage which receives the start signal VST through the first input terminal 301 and the remaining stages (for example, second to fifth stages STG2 to STG5) which receive the carry signal of the previous stage through the first input terminal 301 have the substantially same circuit configuration, except an input signal (that is, the start signal VST or a carry signal of the previous stage) which is received through the first input terminal 301, and may operate in the substantially same way.

Accordingly, for the convenience of description, when the plurality of stages included in the gate driver 300 is described below, a configuration and a driving method of the stages included in the gate driver 300 will be described with respect to the first stage STG1.

In some implementations, switch elements which configure each stage may be implemented by an n-type or a p-type MOSFET transistor. In the following example implementation, even though a p-type transistor is illustrated, but the example implementation of the present disclosure is not limited thereto.

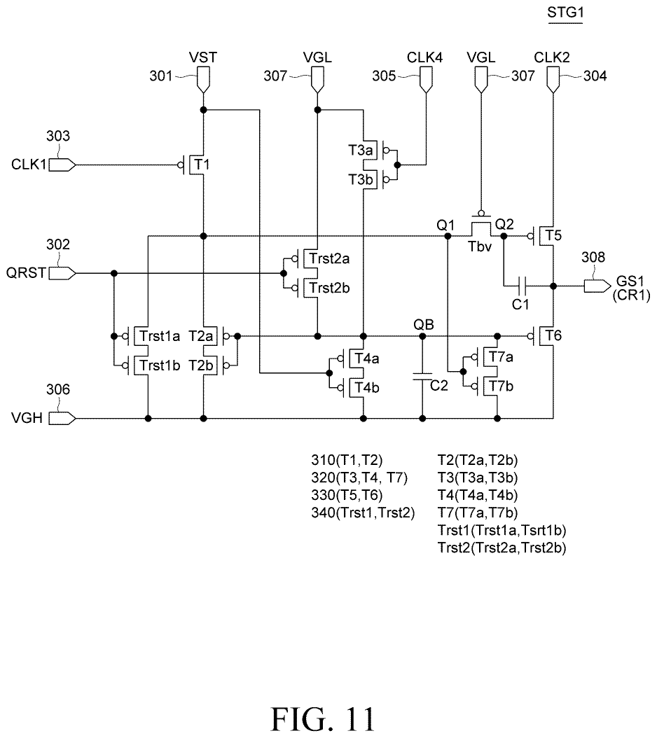

FIG. 11 is a circuit diagram illustrating an example of a first stage included in a gate driver of FIG. 10.

Referring to FIGS. 10 and 11, the first stage STG1 may receive an input signal, for example, the start signal VST, through the first input terminal 301, receive a reset signal RST through the second input terminal 302, and receive a first clock signal CLK1 through the third input terminal 303. Further, the first stage STG1 may receive a second clock signal CLK2 through the fourth input terminal 304 and receive a fourth clock signal CLK4 through the fifth input terminal 305. Further, the first stage STG1 may be connected to the first power source VGH through the first power input terminal 306 and may be connected to the second power source VGL through the second power input terminal 307.

In the example implementation, the first stage STG1 may generate and output a first gate signal GS1 (or a first carry signal CR1) based on an input signal (for example, a start signal VST), the reset signal QRST, the first clock signal CLK1, the second clock signal CLK2, the fourth clock signal CLK4, a voltage of the first power source VGH, and a voltage of the second power source VGL.

To this end, the first stage STG1 may include a first node controller 310, a second node controller 320, an output circuit 330, a reset circuit 340, a first capacitor C1, and a second capacitor C2. According to the example implementation, the first stage STG1 may further include a bridge voltage transistor Tbv.

The first node controller 310 is connected to the first input terminal 301, the third input terminal 303, the first power input terminal 306, and the second node QB. The first node controller 310 may control a voltage of the first node Q1 (or a voltage of a first Q node), based on the start signal VST supplied from the first input terminal 301, the first clock signal CLK1 supplied from the third input terminal 303, a voltage of the first power source VGH supplied from the first power input terminal 306, and a voltage of the second node QB.

To this end, in the example implementation, the first node controller 310 may include the first transistor T1 and the second transistor T2.

The first transistor T1 is connected between the first input terminal 301 and the first node Q1 (or the first Q node) and may include a gate electrode connected to the third input terminal 303. The first transistor T1 is turned on when a first clock signal CLK1 supplied through the third input terminal 303 has a gate-on level (for example, a low level), to electrically connect the first input terminal 301 and the first node Q1. When the first transistor T1 is turned on, the start signal VST which is supplied through the first input terminal 301 may be supplied to the first node Q1.

The second transistor T2 is connected between the first power input terminal 306 and the first node Q1 and may include a gate electrode connected to the second node QB (or a QB node). The second transistor T2 may be turned on or turned off based on a voltage of the second node QB.

For example, when the voltage of the second node QB has a gate-on level (for example, a low level), the second transistor T2 is turned on to electrically connect the first power input terminal 306 and the first node Q1. In this case, a voltage of the first power source VGH of a gate-off level (for example, a high level) which is supplied to the first power input terminal 306 may be supplied to the first node Q1.

In one example implementation, the second transistor T2 may include first and second sub transistors T2a and T2b which are connected in series. Each of the first and second sub transistors T2a and T2b may include a gate electrode which is commonly connected to the second node QB (for example, it is referred to as a dual gate structure). Accordingly, the current leakage by the second transistor T2 may be minimized.

The second node controller 320 is connected to the first input terminal 301, the fifth input terminal 305, the first power input terminal 306, and the second power input terminal 307. The second node controller 320 may control the voltage of the second node QB (or a QB node) based on the start signal VST supplied from the first input terminal 301, the fourth clock signal CLK4 supplied from the fifth input terminal 305, a voltage of the first power source VGH supplied from the first power input terminal 306, and a voltage of the second power source VGL supplied from the second power input terminal 307.

To this end, in the example implementation, the second node controller 320 may include the third transistor T3 and the fourth transistor T4.

The third transistor T3 is connected between the second power input terminal 307 and the second node QB and may include a gate electrode connected to the fifth input terminal 305. The third transistor T3 may be turned on when a fourth clock signal CLK4 supplied through the fifth input terminal 305 has a gate-on level (for example, a low level), to electrically connect the second input terminal 307 and the second node QB. In this case, a voltage of the second power source VGL of a gate-on level (for example, a low level) which is supplied to the second power input terminal 307 may be supplied to the second node QB.

In one example implementation, the third transistor T3 may include third and fourth sub transistors T3a and T3b which are connected in series. Each of the third and fourth sub transistors T3a and T3b may include a gate electrode which is commonly connected to the fifth input terminal 305 (for example, it is referred to as a dual gate structure). Accordingly, the current leakage by the third transistor T3 may be minimized.

The fourth transistor T4 is connected between the first power input terminal 306 and the second node QB and may include a gate electrode connected to the first input terminal 301. The fourth transistor T4 may be turned on when the start signal VST supplied through the first input terminal 301 has a gate-on level (for example, a low level), to electrically connect the first power input terminal 306 and the second node QB. In this case, a voltage of the first power source VGH of a gate-off level (for example, a high level) which is supplied to the first power input terminal 306 may be supplied to the second node QB.

In one example implementation, the fourth transistor T4 may include fifth and sixth sub transistors T4a and T4b which are connected in series. Each of the fifth and sixth sub transistors T4a and T4b may include a gate electrode which is commonly connected to the first input terminal 301 (for example, it is referred to as a dual gate structure). Accordingly, the current leakage by the fourth transistor T4 may be minimized.

In the example implementation, the second node controller 320 may further include a seventh transistor T7.

The seventh transistor T7 is connected between the first power input terminal 306 and the second node QB and may include a gate electrode connected to the first node Q1.

For example, when the voltage of the first node Q1 has a gate-on level (for example, a low level), the seventh transistor T7 is turned on to electrically connect the first power input terminal 306 and the second node QB. When the seventh transistor T7 is turned on, the voltage of the first power source VGH of the gate-off level (for example, a high level) may be supplied to the second node QB.

In one example implementation, the seventh transistor T7 may include seventh and eighth sub transistors T7a and T7b which are connected in series. Each of the seventh and eighth sub transistors T7a and T7b may include a gate electrode which is commonly connected to the first node Q1 (for example, it is referred to as a dual gate structure). Accordingly, the current leakage by the seventh transistor T7 may be minimized.

The output circuit 330 is connected to the fourth input terminal 304, the first power input terminal 306, the third node Q2, and the second node QB. The output circuit 330 may control a voltage of the output terminal 308, based on the second clock signal CLK2 supplied from the fourth input terminal 304, the voltage of the first power source VGH supplied from the first power input terminal 306, a voltage of the third node Q2 (or a first node Q1), and a voltage of the second node QB. For example, the output circuit 330 may output the second clock signal CLK2 or the voltage of the first power source VGH as a first gate signal GS1 (or a first carry signal CR1), based on the voltage of the third node Q2 (or the first node Q1) and the voltage of the second node QB.

To this end, in one example implementation, the output circuit 330 may include a fifth transistor T5 and a sixth transistor T6.

The fifth transistor T5 is connected between the fourth input terminal 304 and the output terminal 308 and may include a gate electrode connected to the third node Q2 (or a second Q node). For example, one electrode of the fifth transistor T5 which is connected to the third node Q2 may be connected to the first node Q1 via the bridge voltage transistor Tbv. The fifth transistor T5 may be turned on or turned off by the voltage of the third node Q2.

Here, the bridge voltage transistor Tbv is connected between the first node Q1 (or a first Q node) and the third node Q2 (or a second Q node) and may include a gate electrode connected to the second power input terminal 307. The gate electrode of the bridge voltage transistor Tbv is connected to the second power input terminal 307 to which a voltage of the second power source VGL having a gate-on level (for example, a low level) is supplied so that the bridge voltage transistor Tbv may maintain a turned-on state at all times. Accordingly, the voltage of the first node Q1 and the voltage of the third node Q2 may have the substantially same value, by the bridge voltage transistor Tbv which maintains a turned-on state. Therefore, the fifth transistor T5 may be turned on or turned off according to the voltage of the first node Q1.

For example, when the voltage of the third node Q2 or the voltage of the first node Q1 has a gate-on level (for example, a low level), the fifth transistor T5 is turned on to electrically connect the fourth input terminal 304 and the output terminal 308. Here, when the fifth transistor T5 is turned on, if the second clock signal CLK2 supplied to the fourth input terminal 304 has a low level, a low level of first gate signal GS1 (or a first carry signal CR1) may be output through the output terminal 308.

The sixth transistor T6 is connected between the first power input terminal 306 and the output terminal 308 and may include a gate electrode connected to the second node QB. The sixth transistor T6 may be turned on or turned off based on a voltage of the second node QB.

For example, when the voltage of the second node QB has a gate-on level (for example, a low level), the sixth transistor T6 is turned on to electrically connect the first power input terminal 306 and the output terminal 308. When the sixth transistor T6 is turned on, a high level of first gate signal GS1 (or the first carry signal CR1) may be output through the output terminal 308.

As described above, the fifth transistor T5 of the first stage STG1 may perform a pull-up function and the sixth transistor T6 of the first stage STG1 may perform a pull-down function.

The first capacitor C1 (or a boosting capacitor) may be connected between the third node Q2 and the output terminal 308. For example, the first capacitor C1 may include a first electrode connected to the third node Q2 and a second electrode connected to the output terminal 308. Further, the first electrode of the first capacitor C1 which is connected to the third node Q2 may be connected to the first node Q1 via the bridge voltage transistor Tbv.

The second capacitor C2 may be connected between the first power input terminal 306 and the second node QB. For example, the second capacitor C2 may include a first electrode connected to the first power input terminal 306 and a second electrode connected to the second node QB. Here, one electrode (for example, a first electrode) of the second capacitor C2 is connected to the first power input terminal 306 to which a voltage of the first power source VGH which is a constant power source is supplied so that the second capacitor C2 may charge a voltage applied to the second node QB and stably maintain a voltage of the second node QB.

In one example implementation, a capacity of the second capacitor C2 may be larger than a capacity of the first capacitor C1. For example, the capacity of the second capacitor C2 may be approximately 1.5 times the capacity of the first capacitor C1. However, this is just example and may vary in various forms depending on a design of the first stage STG1.

The reset circuit 340 is connected to the second input terminal 302, the first power input terminal 306, and the second power input terminal 307. The reset circuit 340 may control the voltages of the first node Q1 and the second node QB, based on the reset signal QRST supplied from the second input terminal 302, the voltage of the first power source VGH supplied from the first power input terminal 306, and the voltage of the second power source VGL supplied from the second power input terminal 307. For example, the reset circuit 340 may reset the voltage of the first node Q1 to the voltage of the first power source VGH and/or reset the voltage of the second node QB to the voltage of the second power source VGL, based on the voltage of the reset signal QRST.

To this end, in one example implementation, the reset circuit 340 may include a first reset transistor Trst1 and a second reset transistor Trst2.

The first reset transistor Trst1 is connected between the first power input terminal 306 and the first node Q1 and may include a gate electrode connected to the second input terminal 302. The first reset transistor Trst1 is turned on when the reset signal QRST supplied to the second input terminal 302 has a gate-on level (for example, a low level), to electrically connect the first power input terminal 306 and the first node Q1. In this case, a voltage of the first power source VGH of a gate-off level (for example, a high level) which is supplied to the first power input terminal 306 may be supplied to the first node Q1. As described above, when the voltage of the first power source VGH is supplied to the first node Q1, the voltage of the first node Q1 may be reset to the gate-off level.

In one example implementation, the first reset transistor Trst1 may include first and second sub reset transistors Trst1a and Trst1b which are connected in series. Each of the first and second sub reset transistors Trst1a and Trst1b may include a gate electrode which is commonly connected to the second input terminal 302 (for example, it is referred to as a dual gate structure). Accordingly, the current leakage by the first reset transistor Trst1 may be minimized.

The second reset transistor Trst2 is connected between the second power input terminal 307 and the second node QB and may include a gate electrode connected to the second input terminal 302. The second reset transistor Trst2 is turned on when the reset signal QRST supplied to the second input terminal 302 has a gate-on level (for example, a low level), to electrically connect the second power input terminal 307 and the second node QB. In this case, a voltage of the second power source VGL of a gate-on level (for example, a low level) which is supplied to the second power input terminal 307 may be supplied to the second node QB. As described above, when the voltage of the second power source VGL is supplied to the second node QB, the voltage of the second node QB may be reset to the gate-on level.

In one example implementation, the second reset transistor Trst2 may include third and fourth sub reset transistors Trst2a and Trst2b which are connected in series. Each of the third and fourth sub reset transistors Trst2a and Trst2b may include a gate electrode which is commonly connected to the second input terminal 302 (for example, it is referred to as a dual gate structure). Accordingly, the current leakage by the second reset transistor Trst2 may be minimized.

As described above, the voltage of the first node Q1 and the second node QB before driving the first stage STG1 may be stabilized by the reset circuit 340, for example, the first reset transistor Trst1 and the second reset transistor Trst2.

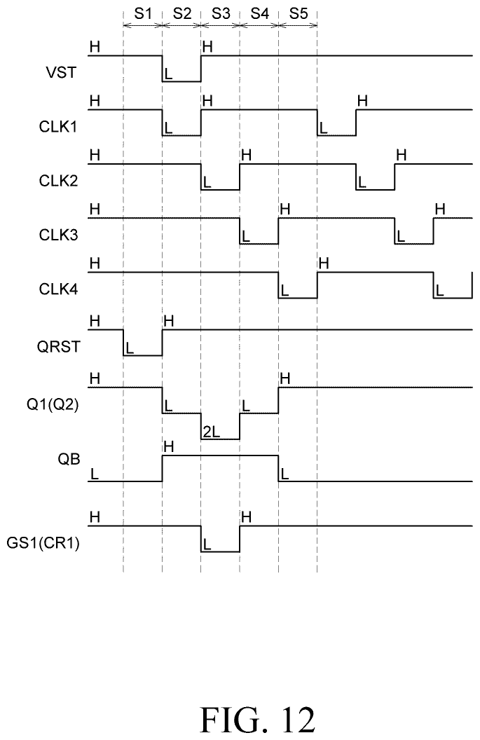

FIG. 12 is a waveform chart for explaining an example of an operation of a first stage of FIG. 11.

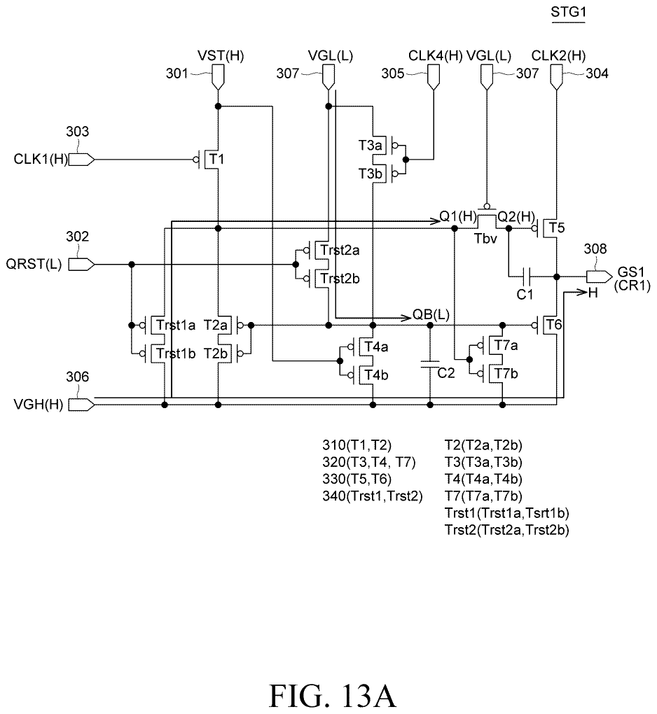

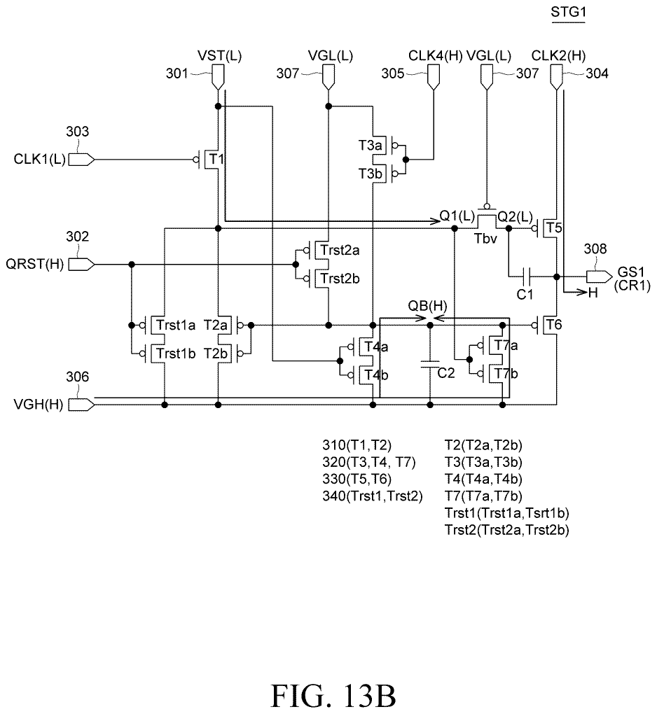

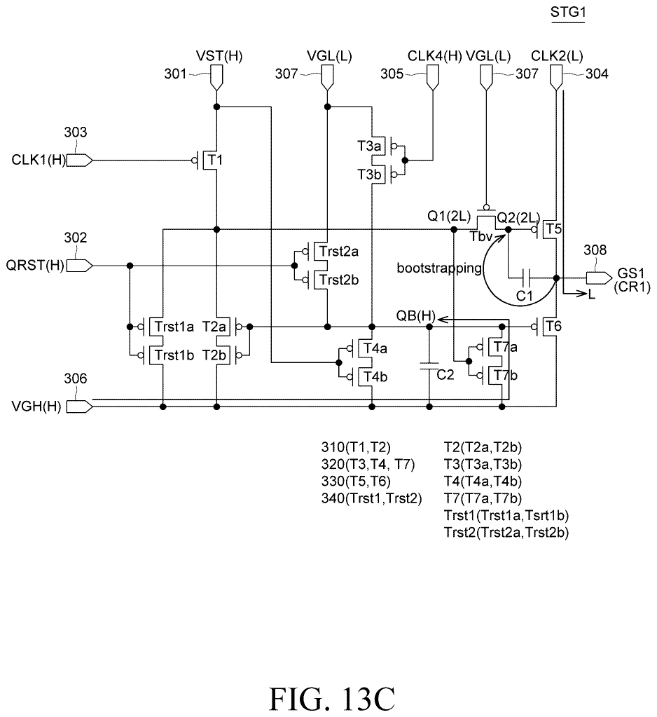

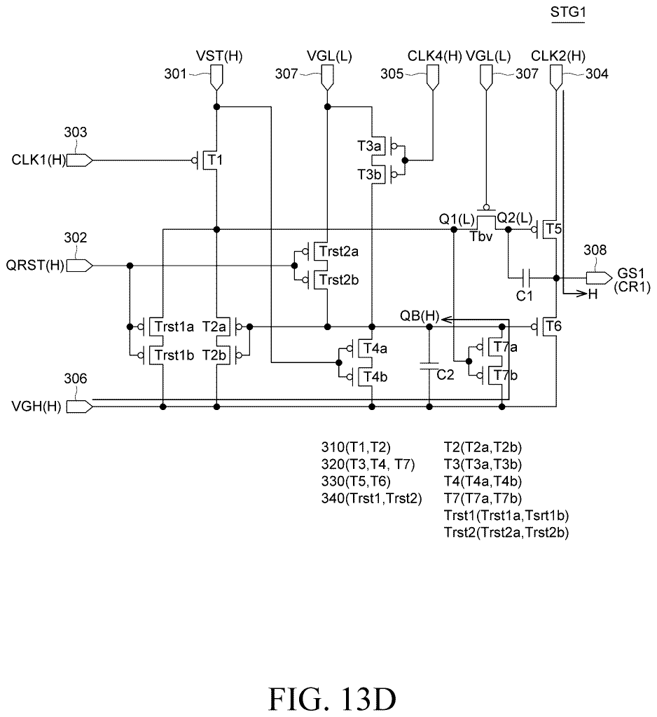

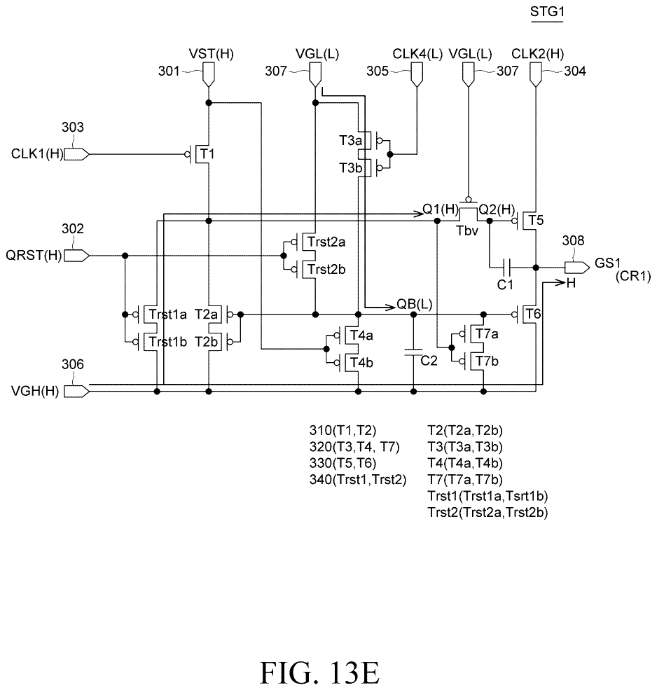

FIGS. 13A to 13E are equivalent circuit diagrams for explaining an example of an operation of a first stage of FIG. 11.

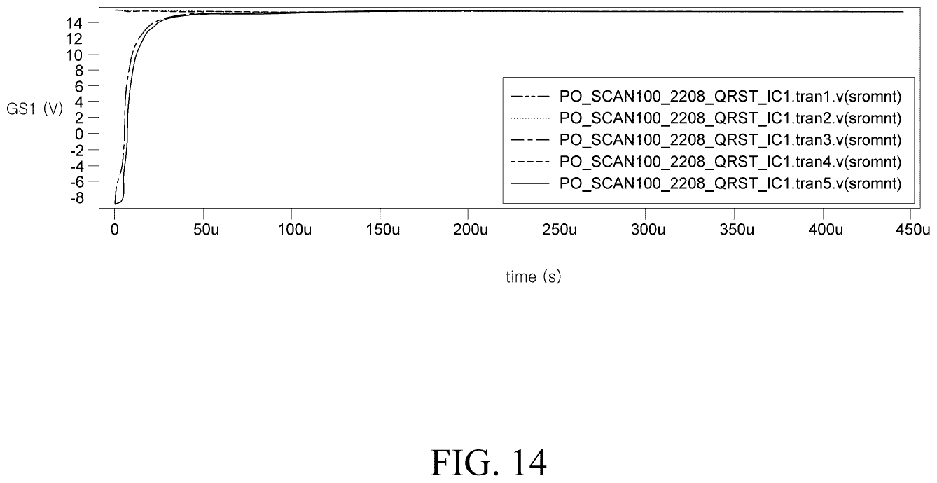

FIG. 14 is a view for explaining an example of a gate signal output from a gate driver of FIG. 10.

In FIGS. 13A to 13E, equivalent circuit diagrams illustrating an example of a state of a first stage STG1 in each of first to fifth periods (S1 to S5) are illustrated.

In FIG. 14, a voltage level of the first gate signal GS1 which is output from the first stage STG1 in accordance with the elapse of time after the fifth period S5 illustrated in FIG. 12 is illustrated.

In some implementations, as described with reference to FIG. 11, the gate electrode of the bridge voltage transistor Tbv is connected to the second power input terminal 307 to which a voltage of the second power source VGL of the gate-on level (for example, a low level) is supplied. Therefore, the bridge voltage transistor Tbv may maintain a turned-on state during all periods when the gate driver 300 is driven, for example, during the first to fifth periods (S1 to S5) and a period thereafter. Accordingly, the voltage of the first node Q1 and the voltage of the third node Q2 may have the substantially same value in all periods when the gate driver 300 is driven.

Referring to FIGS. 11 and 12, the first to fourth clock signals CLK1 to CLK4 may be supplied at different timings. For example, the second clock signal CLK2 may be set as a signal which is shifted by a quarter cycle (for example, one horizontal period) from the first clock signal CLK1. The third clock signal CLK3 may be set as a signal which is shifted by a quarter cycle (for example, one horizontal period) from the second clock signal CLK2. The fourth clock signal CLK4 may be set as a signal which is shifted by a quarter cycle (for example, one horizontal period) from the third clock signal CLK3. For example, a low level L of first clock signal CLK1 may be supplied for a second period S2, a low level L of second clock signal CLK2 may be supplied for a third period S3, a low level L of third clock signal CLK3 may be supplied for a fourth period S4, and a low level L of fourth clock signal CLK4 may be supplied during a fifth period P5.

In some implementations, the high level H (or a high voltage) illustrated in FIG. 12 may correspond to a voltage of the first power source VGH and the low level L (or a low voltage) illustrated in FIG. 12 may correspond to a voltage of the second power source VGL. For example, the voltage of the first power source VGH may be a positive voltage and the voltage of the second power source VGL may be a negative voltage. However, this is example so that the high level H and the low level L are not limited thereto. For example, the high level H of voltage and the low level L of voltage may be set according to a type of a transistor and a usage environment of the display device.

In some implementations, a 2-low level (2L) illustrated in FIG. 12 may be a voltage level corresponding to twice the low level L.

The driving of the gate driver 300 (or the first stage STG1) according to the example implementation of the present disclosure will be described with reference to FIGS. 11, 12, 13A to 13E, as follows.

First, referring to FIGS. 11, 12, and 13A, during the first period S1, the reset signal QRST supplied through the second input terminal 302 may have a low level L. Therefore, the first reset transistor Trst1 and the second reset transistor Trst2 may be turned on or maintain a turned-on state.

During the first period S1, a high level H of voltage of the first power source VGH supplied to the first power input terminal 306 may be supplied to the first node Q1 through the turned-on first reset transistor Trst1. Accordingly, the voltage of the first node Q1 may have a high level H. Further, the bridge transistor Tbv has a turned-on state at all times so that the voltage of the third node Q2 may also have a high level H during the first period S1 so as to correspond to the voltage of the first node Q1.

During the first period S1, a low level L of voltage of the second power source VGL supplied to the second power input terminal 307 may be supplied to the second node QB through the turned-on second reset transistor Trst2. Accordingly, the voltage of the second node QB may have a low level L.

In this case, the sixth transistor T6 which is a pull-down transistor may be turned on by the low level (L) of voltage of the second node QB. The high level (H) of voltage of the first power source VGH is supplied to the output terminal 308 by the turned-on sixth transistor T6 so that the first gate signal GS1 (or the first carry signal CR1) may have a high level H.

Next, referring to FIGS. 11, 12, and 13B, during the second period S2, each of the start signal VST supplied through the first input terminal 301 and the first clock signal CLK1 supplied through the third input terminal 303 may have a low level L. Accordingly, the first transistor T1 may be turned on or maintain a turned-on state by the low level (L) of first clock signal CLK1. Accordingly, the low level (L) of start signal VST which is supplied through the first input terminal 301 during the second period S2 may be supplied to the first node Q1 through the turned-on first transistor T1. Accordingly, the voltage of the first node Q1 may be shifted from the existing high level H to a low level L. Further, the bridge transistor Tbv has a turned-on state at all times so that the voltage of the third node Q2 may also be shifted from the existing high level H to the low level L during the second period S2 so as to correspond to the voltage of the first node Q1.

Further, the fourth transistor T4 may be turned on or maintain a turned-on state by the low level (L) of start signal VST. Accordingly, the high level (H) of voltage of the first power source VGH which is supplied through the first power input terminal 306 during the second period S2 may be supplied to the second node QB through the turned-on fourth transistor T4. Accordingly, the voltage of the second node QB may be shifted from the existing low level L to a high level H.

In some implementations, during the second period S2, the voltage of the first node Q1 has a low level L, so that the seventh transistor T7 may be turned on or maintain a turned-on state so as to correspond to the voltage of the first node Q1. Accordingly, the high level (H) of voltage of the first power source VGH which is supplied through the first power input terminal 306 during the second period S2 may be supplied to the second node QB through the turned-on seventh transistor T7.

In this case, the fifth transistor T5 which is a pull-up transistor may be turned on by a low level L of voltage of the third node Q2 or a voltage of a low level L of first node Q1. The high level (H) of second clock signal CLK2 is supplied to the output terminal 308 by the turned-on fifth transistor T5 so that the first gate signal GS1 (or the first carry signal CR1) may have a high level H.

Next, referring to FIGS. 11, 12, and 13C, a low level (L) of second clock signal CLK2 may be supplied through the fourth input terminal 304 during the third period S3. In this case, the fifth transistor T5 is turned on or maintains a turned-on state by the voltage of the first node Q1 and the voltage of the third node Q2 corresponding thereto so that a low level (L) of second clock signal CLK2 is supplied to the output terminal 308 so that the first gate signal GS1 (or the first carry signal CR1) may have a low level L.

In some implementations, during the third period S3, the voltage of the output terminal 308 is changed from the existing high level H to the low level L so that the voltage of the third node Q2 may drop from a low level L to a 2-low level 2L by the coupling of the first capacitor C1. Accordingly, the fifth transistor T5 may stably maintain the turned-on state. In some implementations, the voltage of the first node Q1 may also drop from the low level L to the 2-low level 2L in accordance with the voltage change of the third node Q2.

Next, referring to FIGS. 11, 12, and 13D, a high level (H) of second clock signal CLK2 may be supplied through the fourth input terminal 304 during the fourth period S4. In this case, the fifth transistor T5 is turned on or maintains a turned-on state by the voltage of the third node Q2 (or a voltage of the first node Q1) so that a high level (H) of second clock signal CLK2 is supplied to the output terminal 308 so that the first gate signal GS1 (or the first carry signal CR1) may have a high level H.

In some implementations, during the fourth period S4, the voltage of the output terminal 308 is changed from the existing low level L to the high level H so that the voltage of the third node Q2 may rise from a 2-low level 2L to a low level L by the coupling of the first capacitor C1. In response to this, the voltage of the first node Q1 may also rise from a 2-low level 2L to a low level L.

First, referring to FIGS. 11, 12, and 13E, during the fifth period S5, the fourth clock signal CLK4 supplied through the fifth input terminal 305 may have a low level L. Accordingly, the third transistor T3 may be turned on or maintain the turned-on state. Accordingly, the low level L of voltage of the second power source VGL may be supplied to the second node QB through the turned-on third transistor T3. Accordingly, the voltage of the second node QB may be shifted from the existing high level H to a low level L.

Further, the second transistor T2 may be turned on by the low level (L) of voltage of the second node QB. Accordingly, the high level H of voltage of the first power source VGH may be supplied to the first node Q1 through the turned-on second transistor T2. Accordingly, the voltage of the first node Q1 may be shifted from the existing low level L to a high level H. In some implementations, the voltage of the third node Q2 may also be shifted from the existing low level L to the high level H in accordance with the voltage change of the first node Q1.

In this case, the sixth transistor T6 which is a pull-down transistor may be turned on by the low level (L) of voltage of the second node QB. The high level (H) of voltage of the first power source VGH is supplied to the output terminal 308 by the turned-on sixth transistor T6 so that the first gate signal GS1 (or the first carry signal CR1) may have a high level H.

In some implementations, in some cases, even after the low level L of first gate signal GS1 (or the first carry signal CR1) is output (for example, after the fifth period S5) due to the current leakage of the first transistor T1, the start signal VST supplied to the first input terminal 301 may also be supplied to the first node Q1.

However, in the case of the gate driver 300 according to the example implementation of the present disclosure, the start signal VST is supplied to the first input terminal 301 to which one electrode of the first transistor T1 is connected. Further, the start signal VST may have a gate-on level (for example, a low level L) only during the second period S2 and have a gate-off level (for example, a high level H) after the second period. Accordingly, after outputting the low level (L) of first gate signal GS1 (or the first carry signal CR1), for example, after the fifth period S5, the voltage of the first node Q1 and the voltage of the third node Q2 are stably maintained at a high level H. Therefore, the fifth transistor T5 which is a pull-up transistor may stably maintain a turned-off state.

Therefore, further referring to FIG. 14, after the fifth period S5, the first gate signal GS1 (or the first carry signal CR1) may stably maintain the gate-off level (for example, a high level H) by the turned-on sixth transistor T6.

In some implementations, as described above, the plurality of stages STG1 to STG5 included in the gate driver 300 has the substantially same configuration except an input signal received through the first input terminal 301. Therefore, the remaining stages except the first stage STG1 may output one or more output signals (for example, gate signals and carry signals) by the substantially same operation as the first stage STG1.

As described above, in the gate driver according to the example implementations of the present disclosure and the display device including the same, a first node controller which controls a first node (or a Q1 node) of a stage may be connected to an input terminal to which a start signal is input. Here, the start signal may be maintained at a gate-off level (high level) after a gate-on level (low level) of gate signal is output.

Accordingly, after the gate-on level (low level) of gate signal is output, the first node (or Q1 node) of the corresponding stage may be stably maintained at a gate-off level (high level) and may also stably maintain the gate signal at a gate-off level (high level), in response to this.

A gate driver according to the example implementations of the present disclosure can also be described as follows:

A gate driver according to an example implementation of the present disclosure includes a plurality of stages which are cascaded to each other and configured to output a plurality of gate signals based on an input signal, a reset signal, at least one clock signal among first, second, third and fourth clock signals, a first power source, and a second power source which has a voltage level lower than the first power source, wherein a first stage, among the plurality of stages, includes a first node controller configured to control a voltage of a first node based on the input signal, the first clock signal, the first power source, and a voltage of a second node, a second node controller configured to control a voltage of the second node based on the input signal, the fourth clock signal, the first power source, and the second power source, an output circuit configured to output the second clock signal or a voltage of the first power source, based on a voltage of a third node and the voltage of the second node and a bridge voltage transistor connected between the first node and the third node.

A voltage of the second power source may be supplied to a gate electrode of the bridge voltage transistor.

The bridge voltage transistor may be configured to maintain a turned-on state.

The voltage of the first node and the voltage of the third node may have the same voltage level.

The first node controller may include a first transistor which is connected between a first input terminal to which the input signal is supplied and the first node and includes a gate electrode connected to a third input terminal to which the first clock signal is supplied and a second transistor which is connected between a first power input terminal to which the voltage of the first power source is supplied and the first node and includes a gate electrode connected to the second node.

The second node controller may include a third transistor which is connected between a second power input terminal to which a voltage of the second power source is supplied and the second node and includes a gate electrode connected to a fifth input terminal to which the fourth clock signal is supplied and a fourth transistor which is connected between a first power input terminal to which the voltage of the first power source is supplied and the second node and includes a gate electrode connected to a first input terminal to which the input signal is supplied.

The second node controller may further include a seventh transistor which is connected between the first power input terminal and the second node and includes a gate electrode connected to the first node.

The output circuit may include a fifth transistor which is connected between a fourth input terminal to which the second clock signal is supplied and an output terminal from which the gate signal is output and includes a gate electrode connected to the third node and a sixth transistor which is connected between a first power input terminal to which the voltage of the first power source is supplied and the output terminal and includes a gate electrode connected to the second node.

The first stage may further include a first capacitor connected between the third node and the output terminal and a second capacitor connected between the second node and the first power input terminal.

The first stage may further include a reset circuit configured to control the voltage of the first node and the voltage of the second node based on the reset signal, the first power source, and the second power source.

The reset circuit may include a first reset transistor which is connected between a first power input terminal to which the voltage of the first power source is supplied and the first node and includes a gate electrode connected to a second input terminal to which the reset signal is supplied and a second reset transistor which is connected between a second power input terminal to which a voltage of the second power source is supplied and the second node and includes a gate electrode connected to the second input terminal.

A gate driver according to other example implementation of the present disclosure includes a plurality of stages which are cascaded to each other and configured to output a plurality of gate signals based on an input signal, a reset signal, at least one clock signal among first, second, third and fourth clock signals, a first power source, and a second power source which has a voltage level lower than the first power source, wherein a first stage, among the plurality of stages, includes a first node controller configured to control a voltage of a first node based on the input signal, the first clock signal, the first power source, and a voltage of a second node, a second node controller configured to control the voltage of the second node based on the input signal, the fourth clock signal, the first power source, and the second power source, an output circuit configured to output the second clock signal or a voltage of the first power source, based on a voltage of a third node and the voltage of the second node and a reset circuit configured to control the voltage of the first node and the voltage of the second node based on the reset signal, the first power source, and the second power source.

The reset circuit may include a first reset transistor which is connected between a first power input terminal to which the voltage of the first power source is supplied and the first node and includes a gate electrode connected to a second input terminal to which the reset signal is supplied and a second reset transistor which is connected between a second power input terminal to which a voltage of the second power source is supplied and the second node and includes a gate electrode connected to the second input terminal.

The voltage of the first node and the voltage of the third node may have the same voltage level.

The first stage may further include a bridge voltage transistor which is connected between the first node and the third node and includes a gate electrode connected to a second power input terminal to which a voltage of the second power source is supplied.

The bridge voltage transistor may be configured to maintain a turned-on state.

A display device according to the example implementations of the present disclosure can also be described as follows:

A display device according to an example implementation of the present disclosure includes a display panel which includes a plurality of pixels; and a gate driver according to the example implementation of the present disclosure, wherein the plurality of gate signals are output to the plurality of pixels.

A display device according to other example implementation of the present disclosure includes a display panel which includes a plurality of pixels; and a gate driver according to the other example implementation of the present disclosure, wherein the plurality of gate signals are output to the plurality of pixels.

Although the example implementations of the present disclosure have been described in detail with reference to the accompanying drawings, the present disclosure is not limited thereto and may be embodied in many different forms without departing from the technical concept of the present disclosure. Therefore, the example implementations of the present disclosure are provided for illustrative purposes only but not intended to limit the technical concept of the present disclosure. The scope of the technical concept of the present disclosure is not limited thereto. Therefore, it should be understood that the above-described example implementations are illustrative in all aspects and do not limit the present disclosure. The protective scope of the present disclosure should be construed based on the following claims, and all the technical concepts in the equivalent scope thereof should be construed as falling within the scope of the present disclosure.

What is claimed is:

1. A gate driver, comprising:
a plurality of stages which are cascaded to each other and configured to output a plurality of gate signals based on (i) an input signal, (ii) a reset signal, (iii) at least one clock signal among first, second, third and fourth clock signals, (iv) a first power source, and (v) a second power source which has a voltage level lower than the first power source,
wherein a first stage, among the plurality of stages, includes:
a first node controller circuit configured to control a voltage of a first node based on the input signal, the first clock signal, the first power source, and a voltage of a second node;
a second node controller circuit configured to control a voltage of the second node based on the input signal, the fourth clock signal, the first power source, and the second power source;
an output circuit configured to selectively output the second clock signal or a voltage of the first power source, based on a voltage of a third node and the voltage of the second node; and
a bridge voltage transistor connected between the first node and the third node.

2. The gate driver according to claim 1, wherein a voltage of the second power source is supplied to a gate electrode of the bridge voltage transistor.

3. The gate driver according to claim 2, wherein the bridge voltage transistor is configured to maintain a turned-on state.

4. The gate driver according to claim 1, wherein the voltage of the first node and the voltage of the third node have a same voltage level.

5. The gate driver according to claim 1, wherein the first node controller circuit includes
a first transistor which is connected between (i) a first input terminal to which the input signal is supplied and (ii) the first node, and includes a gate electrode connected to a third input terminal to which the first clock signal is supplied; and
a second transistor which is connected between (i) a first power input terminal to which the voltage of the first power source is supplied and (ii) the first node, and includes a gate electrode connected to the second node.

6. The gate driver according to claim 1, wherein the second node controller circuit includes:
a third transistor which is connected between (i) a second power input terminal to which a voltage of the second power source is supplied and (ii) the second node, and includes a gate electrode connected to a fifth input terminal to which the fourth clock signal is supplied; and
a fourth transistor which is connected between (i) a first power input terminal to which the voltage of the first power source is supplied and (ii) the second node, and includes a gate electrode connected to a first input terminal to which the input signal is supplied.

7. The gate driver according to claim 6, wherein the second node controller circuit further includes a seventh transistor which is connected between (i) the first power input terminal and (ii) the second node, and includes a gate electrode connected to the first node.

8. The gate driver according to claim 1, wherein the output circuit includes:
a fifth transistor which is connected between (i) a fourth input terminal to which the second clock signal is supplied and (ii) an output terminal from which a gate signal among the plurality of gate signals is output, and includes a gate electrode connected to the third node; and
a sixth transistor which is connected between (i) a first power input terminal to which the voltage of the first power source is supplied and (ii) the output terminal, and includes a gate electrode connected to the second node.

9. The gate driver according to claim 8, wherein the first stage further includes:
a first capacitor connected between the third node and the output terminal; and
a second capacitor connected between the second node and the first power input terminal.

10. The gate driver according to claim 1, wherein the first stage further includes:
a reset circuit configured to control the voltage of the first node and the voltage of the second node based on the reset signal, the first power source, and the second power source.

11. The gate driver according to claim 10, wherein the reset circuit includes:
a first reset transistor which is connected between (i) a first power input terminal to which the voltage of the first power source is supplied and (ii) the first node, and includes a gate electrode connected to a second input terminal to which the reset signal is supplied; and
a second reset transistor which is connected between (i) a second power input terminal to which a voltage of the second power source is supplied and (ii) the second node, and includes a gate electrode connected to the second input terminal.

12. A gate driver, comprising:
a plurality of stages which are cascaded to each other and configured to output a plurality of gate signals based on (i) an input signal, (ii) a reset signal, (iii) at least one clock signal among first, second, third and fourth clock signals, (iv) a first power source, and (v) a second power source which has a voltage level lower than the first power source,
wherein a first stage, among the plurality of stages, includes:
a first node controller circuit configured to control a voltage of a first node based on the input signal, the first clock signal, the first power source, and a voltage of a second node;
a second node controller circuit configured to control the voltage of the second node based on the input signal, the fourth clock signal, the first power source, and the second power source;
an output circuit configured to selectively output the second clock signal or a voltage of the first power source, based on a voltage of a third node and the voltage of the second node; and
a reset circuit configured to control the voltage of the first node and the voltage of the second node based on the reset signal, the first power source, and the second power source.

13. The gate driver according to claim 12, wherein the reset circuit includes:
a first reset transistor which is connected between (i) a first power input terminal to which the voltage of the first power source is supplied and (ii) the first node, and includes a gate electrode connected to a second input terminal to which the reset signal is supplied; and
a second reset transistor which is connected between (i) a second power input terminal to which a voltage of the second power source is supplied and (ii) the second node, and includes a gate electrode connected to the second input terminal.

14. The gate driver according to claim 12, wherein the voltage of the first node and the voltage of the third node have a same voltage level.

15. The gate driver according to claim 12, wherein the first stage further includes:
a bridge voltage transistor which is connected between the first node and the third node and includes a gate electrode connected to a second power input terminal to which a voltage of the second power source is supplied.

16. The gate driver according to claim 15, wherein the bridge voltage transistor is configured to maintain a turned-on state.

17. A display device, comprising:
a display panel which includes a plurality of pixels; and
a gate driver according to claim 1, wherein the plurality of gate signals are output to the plurality of pixels.

18. A display device, comprising:
a display panel which includes a plurality of pixels; and
a gate driver according to claim 12, wherein the plurality of gate signals are output to the plurality of pixels.
